(19) United States
(12) Patent Application Publication
(10) Pub. No.: US 2016/0117732 A1
(43) Pub. Date: Apr. 28, 2016

(54) User Need Estimation On Mobile Device And Its Applications

(71) Applicant: Jian Zou, Chapel Hill, NC (US)

(72) Inventor: Jian Zou, Chapel Hill, NC (US)

(21) Appl. No.: 14/522,141

(22) Filed: Oct. 23, 2014

(51) Int. Cl. G06Q 30/02; H04W 4/02

(52) U.S. Cl. CPC G06Q 30/0261; H04W 4/02; G06Q 30/0267; G06Q 30/0256; G06Q 30/0242; G06Q 30/0264

(57) ABSTRACT

Methods, program products and systems of user need estimation on mobile device and its applications are disclosed. For example, a method includes: collecting a plurality of information items on a mobile device at or around a given time; determining, using the collected information items, a likely mode of the activities of a person who at said given time is in close physical proximity to the device, the likely mode being one or more modes among three or more predetermined possible modes; and performing, in response to the likely mode or intermediate results of the determination, a predetermined task.

### TECHNICAL FIELD

Some embodiments are related to mobile computerized devices.

### BACKGROUND

Mobile devices have become widely adopted by the public. Mobile devices include smart phones and feature phones, personal digital assistant (PDA) devices, tablets, laptops, wearable computing devices in various forms, and other portable computing devices. Portable sensors capable of transmitting their readings wirelessly can be considered as mobile devices as well.

A mobile device often has only one user for a period of time. Accurate estimation of the user's needs or intents in a timely fashion can enable such a device to provide a highly personalized user experience during that time. Need or intent will be referred to as need throughout this disclosure for convenience. Computing, memory, power and communications resources available on a mobile device can be limited. Accurate estimation of the user's needs in a timely fashion can allow more efficient use of those resources.

Mobile devices have emerged as promising advertising platforms. Advertising can be defined as communicating with the purpose or intent to encourage, persuade, or manipulate an audience to take or continue to take certain actions, or adopt or continue to hold certain views. Mobile advertising (i. e. advertising via mobile devices), has experienced rapid growth in recent years. An ideal mobile advertising system should consistently place advertisements that are highly relevant to a user's needs, in a timely and pleasant fashion. Advertisements placed without an accurate and timely understanding of the user's needs are likely to be irrelevant, resulting in distraction to the user, wasted effort by the advertiser and advertising system, and lost opportunity to both the user and the advertiser.

Many advertising systems and methods are known in the art. Some of them rely on keywords in a search query initiated by or a command issued by a user to understand his current needs. Some also use a keyword tagged to an advertisement to understand the product, service, or information promoted by the advertisement and to determine if it satisfies a human need represented by other keywords. Mobile device users usually do not constantly use keyboard or voice to input a search query or issue a command on their devices. When a mobile device's user is not expressing her needs through a search query or a command, keywords related to her needs are not available directly through search query or command. Some methods known in the art can generate keywords related to the user's need based on other information. For example, contextual advertising relies on a media the user may be consuming to derive keywords about her needs. However, those methods in the art are limited in terms of the variety of situations they can be applied and may have limited effectiveness.

Mobile advertising has a few unique characteristics that make it different from online advertising targeting desktop computers. First, a mobile device is usually carried or worn by its user in close physical proximity. Real time, near real time, or recent information about the user can be obtained through a variety of sensors or instruments on the device, such as her geographic location.

Second, the form factor of some mobile devices is small to ensure their mobilities. Small mobile devices such as some smart phones or some wearable computing devices can have small display screens, making simultaneous display of more than one advertisement impractical or impossible, except for full-screen interstitial advertising. Even full-screen interstitial advertising may only be able to display one advertisement at a time on a small device such as one with the form of a wrist watch. Some mobile devices, such as some wearable computing devices, have no display at all, making visual advertising impossible.

### SUMMARY

Methods, program products and systems of user need estimation on mobile device and its applications are disclosed. For example, a method can include: collecting a plurality of information items on a mobile device at or around a given time; determining, using the collected information items, a likely mode of the activities of a person who at the given time is in close physical proximity to the device, the likely mode being one or more modes among three or more predetermined possible modes; and performing, in response to the likely mode or intermediate results of the determination, a predetermined task.

The techniques described in this specification can be implemented to achieve the following exemplary advantages.

In some embodiments, when properly implemented and configured, they enable a mobile device to provide a more personalized and satisfying user experience. In some embodiments, when properly implemented and configured, they enable a mobile device to more efficiently utilize available resources, such as computing, memory, power, and communications resources, to fulfill the needs of its user, without explicit instructions or direct attentions from the user. In some embodiments, when properly implemented and configured, they help marketers to place timely and relevant advertisements to reach a user of a mobile device.

The details of exemplary embodiments of user need estimation on mobile device and its applications are set forth in the accompanying drawings and the description below. Other aspects, features, advantages, and requirements will become apparent from the description, drawings and claims.

### BRIEF DESCRIPTION OF DRAWINGS

FIG. 1 is a block diagram providing an overview of some exemplary embodiments of user need estimation on mobile device and its applications.

FIG. 2 is a flowchart of an exemplary process for user mode estimation using a Naïve Bayes classification method.

FIG. 3 is a flowchart of an exemplary process for determining prior likelihood of each possible user mode for a given time.

FIG. 4 is a flowchart of an exemplary process of determining a conditional probability density of a collected information item in a given mode.

FIG. 5 is a diagram illustrating exemplary techniques of advertising based on user need estimation on mobile device.

FIG. 6 is a diagram illustrating exemplary components in an advertisement stored in an advertisement store.

FIG. 7 is a flowchart illustrating an exemplary process of determining a total relevance value between an advertisement and an ad request.

FIG. 8 is a flowchart illustrating an exemplary process of determining a subject relevance score using the keyword in an advertisement and a need-word list.

FIG. 9 is a flowchart illustrating an exemplary process of determining a subject relevance score using the R-table in an advertisement and a need-code list.

FIG. 10 is a flowchart illustrating an exemplary process of determining availability score.

FIG. 11 shows an exemplary word relevance table.

FIG. 12 shows exemplary R-tables of exemplary advertisements.

FIG. 13 is a block diagram illustrating functional components of an exemplary user need estimation system.

FIG. 14 is a block diagram illustrating functional components of an exemplary advertising based on user need estimation system.

### Detailed Description

### Mode of Person's Activities, Implied Need and Mobile Device

Activities of a live person at a given time can be classified into one or more modes among two or more possible ones that have been predetermined. The activities can be mental, physical, or both. The predetermined possible modes can be predetermined collections or sets of those activities. For example, the predetermined possible modes can consist of two modes: sleeping mode and wakeful mode. The person's activities at the given time can be classified into wakeful mode if she is awake at that time, or sleeping mode if she is asleep at that time. In this disclosure, the total number of all predetermined possible modes into which a single person's activities at any given time can be classified is finite. However, the number of all possible activities that can be classified into a given predetermined possible mode can be either finite or infinite. For convenience, the mode into which a person's activities at a given time are classified can be referred to as the mode of the activities of the person, the mode of the person, or the mode the person is in, at that time. Classifying a person's activities at a time into one or more modes can be referred to as classifying her activities or mode classification at that time. When a person's activities at a given time are not known for certain, forming an educated guess of one or more modes into which they would likely be classified, among predetermined possible ones, based on partial or indirect observation of them, or information related to them, can be referred to as estimating her mode or mode estimation at that time. Those modes in the guess can also be referred to as the estimated modes.

Two types of modes exist based on the way they are defined. Type I modes can be defined without any reference to the corresponding classification process. Among them, some can be defined entirely in terms of physiology, such as sleeping mode and wakeful mode. Some can be defined partially in terms of physiology. For example, a study mode of a person can be defined to include all activities of the person, when he is awake and, at the same time, is in a cognitive process of trying to understand or better understand a subject. Being awake can have a physiological definition. Some can be defined with no reference to human physiology. Examples include those that are defined based solely on physical movement the person is making, such as stationary mode, shaking mode, walking mode, jumping mode, running mode, biking mode, driving-motorized-ground-vehicle mode, flying mode and other-movement mode. Each of these modes can be precisely defined using some characteristics of his physical movement. For example, stationary mode can be defined to include all his activities when his speed relative to the ground is less than a given threshold, such as 0.01 meters per second. Other examples include modes defined entirely based on the mental intent of the person, such as working mode, studying mode, shopping mode, exercising mode, eating mode, entertaining mode and other-mental-intent modes. For example, working mode can be defined to include all his activities when he is doing a job.

Type II modes can be defined implicitly by a well-defined classification process. A well-defined classification process means that details of the classification process, including inputs, parameters used, steps performed, ordering of those steps, and all other details, are sufficiently clear so that a person with ordinary skills in the art can implement it without ambiguity. A well-defined classification process can define mode implicitly. That is, a mode can be defined to include all activities that can be classified into a particular outcome by the classification process. A mode defined implicitly may not have a specific definition or meaning other than that derived from the classification process.

In some exemplary embodiments, an “others-in-the-group” or “none-of-the-above-in-the-group” mode can be included in a group of modes. Such a mode can be defined to include a person's activities which can not be classified into any other mode in the group. It can make the group comprehensive (i.e. covering all possible activities of a person at a given time).

Definition of a mode can be specific to a person, given time and embodiment. In some exemplary embodiments, a mode group can be mutually exclusive (i.e. the person can not be in more than one mode within the group at a given time). In some exemplary embodiments, a mode group can be mutually exclusive and comprehensive. In some exemplary embodiments, a person can be in more than one mode within a mode group at one time. In some exemplary embodiments, possible modes of a person at different times can be different. For example, possible modes of a person at 12 a.m. of a particular day can include sleeping mode and wakeful mode. Possible modes of the same person at 12 p.m. the same day can include eight different modes in a comprehensive and mutually exclusive mode group, including sleeping mode, working mode, grocery shopping mode, cooking mode, eating mode, studying mode, entertaining mode, and none-of-the-above mode. A first group of modes can be independent from a second group of modes in the sense that being classified into a mode among the first group does not affect which mode the same activities can be classified in within the second group. For example, a group of modes whose definitions are based on physical movements can be independent from another group of modes whose definitions are based on mental intents. A person can be in both working mode and walking mode at the same time. She also can be in shopping mode and walking mode at the same time.

In some exemplary embodiments, when properly defined, the mode of a person imply some of his needs. A need implied by a mode means a common, likely or steady need of a person when his activities can be classified into that mode. A person can have many needs. They can be different at different times. When he is in a properly defined mode, some of his needs can be common, likely or steady. In some exemplary embodiments, one of a person's needs while he is in sleeping mode can be not being woken for issues that are less important than having a good sleep. He will have that need regardless of other needs he may or may not have at the same time, his sleeping location, or his physiological state, as long as he is in sleeping mode. In another exemplary embodiment, one of a person's needs in grocery shopping mode could be reviewing available grocery items around a specific geographic location and deciding which items to buy. As long as he remains in grocery shopping mode, he can be assumed to have this grocery-item-reviewing need. That need can decrease or disappear when he shifts to another different mode.

In those exemplary embodiments, since mode can imply needs, classifying a person's activities or estimating his mode at a given time can be helpful in understanding at least some of his needs at or around that time. This understanding can be useful to a mobile device used by that person. If the mobile device can know or have an educated guess about the mode its user is currently in, the device can use that knowledge to estimate the current and anticipate the future needs of the user. It can then configure itself, control applications running on the device, control other devices or do something else to better satisfy those needs. For example, in some exemplary embodiments, when the user is estimated to be in sleeping mode, a task of turning the screen on and displaying some visual and audio information can be postponed or canceled by the device as it is likely that the visual display on the screen would not be watched by the user while he is in sleeping mode and audible sound output could be perceived as annoying. The device could also mute its speaker for incoming phone calls in order not to disturb him while in sleeping mode.

That knowledge can also be useful to place relevant advertisement (abbreviated as ad below for convenience) to reach the user at the right time. The device can transmit data on one or more estimated modes, inputs, or intermediate results of the mode estimation process, and/or other information about the device to a remote server over a communications network. Upon receiving the data, the server can select or even create relevant ads. The server can then send or request different computing devices to send, one or more such ads to the device or some other advertising platform for them to be exposed to the user. The user will be more responsive to ads that are relevant to his current needs than those that are not. For example, a user can park his car in a parking lot then walk into a shopping center. His mode can change from driving-motorized-ground-vehicle mode (i. e. driving mode) into walking mode. His needs for refueling his car, which can be implied in driving mode, can decrease. His need for food or drink near or within the shopping center, which can be implied by walking mode, can increase. An ad of nearby vehicle fuel stations would be more relevant while in driving mode. The same ad can become less relevant or irrelevant after his mode changes into walking mode. On the other hand, an ad from a nearby restaurant or coffee shop can become more relevant after his mode changes, and therefore potentially be better received and more effective.

### Mobile Devices can be Well Positioned to Estimate User Mode

A person's activities can directly affect a mobile device carried by her. For example, when she is interacting with the device, certain inputs from her can be detected on the device, such as voice command, clicking, gesture or the like. When she is making a mobile phone call via the device, a phone call application or program is made running on the device. A person's activities can affect and be affected by her surroundings. For example, her activities can generate sound in her close physical proximity and environmental noise can prevent her from sleeping. A person's activities are usually related to the geographic location of the person. For example, a person is much more likely to be awake than asleep when she is located at a busy street, a sports stadium, a market, or a restaurant. She is also much more likely to be performing a job than shopping when she is located at a construction site, factory or office building. A person's activities can affect her own physiological state. For example, rigorous physical activities usually will raise heart rate. Long period without food can cause low blood glucose level.

A mobile device in close physical proximity to its user can be well positioned to estimate the mode her activities is in. A mobile device can travel together with its user. A mobile device can be equipped with a variety of sensors, for example, a touch screen, microphone, camera, wireless transceiver, accelerometer, gyroscope, magnetometer, thermometer, heart rate sensor, chip capable of measuring blood glucose level or the like. Some of those sensors can be configured to collect information about the device itself or the surroundings of the device. Some can be configured to take physiological measurements of the user through contact or non-contact means. When the device is located in close physical proximity to its user, the information collected on the device can contain information of the user's current activities and thus can be used to estimate the mode she is in. In some exemplary embodiments and under the right circumstances, sound level detected on the device can be highly correlated with that heard by the user at the same time. In that case, detected sound level can contain information about the user's activities and can be used to estimate her mode. In another exemplary embodiment, when the device is carried by the user either by hand, in his pocket, or in a carry-on bag, geographic location of the device can be very close to that of the user, thus providing information about the user's activities and the mode she is in.

The phrase “close physical proximity” can have different meanings for different devices, sensors on the devices, or under different circumstances. In some exemplary embodiments implemented on wearable computing device, close physical proximity can mean a wearable device being worn by or attached to the user. In other embodiments, close physical proximity means a mobile device and its user are within the same room if they are inside a building. In an embodiment, if a device is located in close physical proximity to its user, then she is also located in close physical proximity to the device and vice versa. Based on existing technology, in some embodiments, when a device is less than 30 meters away from its user, they can be considered as being located within each other's close physical proximity. That distance can change if effective range of sensors on mobile device can extend beyond that. Throughout the disclosure it is assumed that a mobile device is located in its user's close physical proximity at or around the time for which user mode estimating is applicable.

### User Mode Estimation

Some exemplary embodiments of methods of user need estimation on mobile device and its applications can contain three exemplary steps: collecting a plurality of information items on a mobile device at or around a given time; determining, using the collected information items, a likely mode of the activities of a person who at the given time is in close physical proximity to the device, the likely mode being one or more modes among three or more predetermined possible modes; and performing, in response to the likely mode or intermediate results of the determination, a predetermined task. These exemplary steps do not have to be in the order they are listed. For example, the step of collecting information items, the step of determining a likely mode, or the step of performing a predetermined task can commence before any other step is completed.

In some exemplary embodiments, the step of determining a likely mode of the activities of a person who at the given time is in close physical proximity to the device with the likely mode being one or more modes among three or more predetermined possible modes can be considered as a special classification problem. The following is a brief description of a general classification problem well known in the art. Generally speaking, in a classification problem, a classification method uses a set of features or attributes to characterize each object, where these features or attributes should be relevant to the problem at hand. Supervised classification methods means that a human both has determined into what classes an object may be categorized and also has provided a set of sample objects with known classes. This set of known objects can be called the training set because it is used by the classification methods to learn how to classify objects. There can be two phases in constructing a classifier for supervised classification methods. In the training phase, the training set can be used to decide how the attributes ought to be processed and used in order to separate the various classes of objects. In the application phase, the knowledge gained in training phase can be applied to a set of objects that do not have known classes in order to determine what their classes are likely to be. Classification problems can be complex and difficult. Practical methods for classification can involve a heuristic approach intended to find a “good-enough” solution to a particular problem. The choice of the best features or attributes can be an important part of developing a good classifier. Several groups of classification methods are well known in the art, such as neural network methods, classification tree methods, k-nearest neighbors methods, Naïve Bayes methods, random forest methods, support vector machine methods, and others. In those embodiments where the step of determining the likely mode is considered as a special classification problem, the object being classified is the activities of the person and the features or attributes of the object used for classification are the information items being collected. It will be understood by persons of ordinary skills in the art that some information items being collected are those that can be affected or influenced by the activities and thus contain information of those activities, such as sound level detected on the device. They may or may not be attributes or features of the activities in a traditional sense but they are always treated as such in those embodiments.

Exemplary embodiments using supervised classification methods in the step of determining a likely mode are described in details in this disclosure. It will be understood by persons of ordinary skills in the art that unsupervised classification method can also be used in that step. In that case, the predetermined possible modes of a person's activities will be implicitly defined by the classification process used in the unsupervised classification method.

Some exemplary embodiments described below use Naïve Bayes classification methods. The Naïve Bayes classification methods are based on the Bayes' theorem of conditional probability. Bayes' theorem is not stated in this disclosure as it is a mathematical result that is well understood by persons of ordinary skills in the art. Naïve Bayes classification methods assume that the value of one feature is unrelated to presence or absense of any other feature. They make use of the attributes contained in the training set by observing them individually, independent of one another. In some cases it can also be observed that a particular implementation of a Naïve Bayes classification method can outperform many implementations of other comparatively complex classification methods under particular circumstances. There is a widely held observation in the art that though simple in concept, properly implemented Naïve Bayes classification methods can work well in many classification problems (Caruana, and Niculescu-Mizil, 2006, An empirical comparison of supervised learning algorithms, Proceedings of the 23rd international conference on Machine learning).

It will be understood by persons of ordinary skills in the art that the employment of specific methods in the exemplary embodiments are for illustrative purposes only. For example, Naïve Bayes classification methods used in exemplary embodiments could be replaced by any of the various classification methods known and employed in the art, including those listed above. An exemplary embodiment using classification tree method can be described in the paragraph below.

In this embodiment, there can be only two predetermined possible modes, anxious mode and not-anxious mode, that a user's activities can be classified into at a given time. Two information items can be collected on a wearable mobile device. The user is within the device's close physical proximity at that time. The first item, the average heart rate of the user, is measured by a heart rate sensor on the device over a period of time, e. g. 10 seconds, that is centered at given time. A period of time centered at given time means a time interval which begins before and ends after the given time and whose midpoint is at the given time. The average heart rate measured is represented by a numerical value, h, of unit beats per minute. The second item is the standard deviation of the magnitudes of an onboard 3-D accelerometer's readings at a given frequency, e. g. 20 Hertz, over a period of time, e. g. 5 seconds, that is also centered at the given time. The standard deviation is represented by a numerical value, s, of unit metre per second squared. The examplary embodiment using a classification tree method in the step of determining a likely mode of the person's activities comprises the following steps: collecting the average heart rate of the user on the device for a given time as described above; collecting the standard deviation on the device for the given time as described above; comparing the collected heart rate h against a predetermined threshold, tₕ; when h is greater than tₕ, comparing the collected standard deviation s against a predetermined threshold, tₛ₁; determining the likely mode to be anxious mode if h is greater than and s is greater than tₛ₁; determining it to be non-anxious mode if h is greater than tₕ but s is less than or equal to tₛ₁; when h is less than or equal to tₕ, comparing s against another predetermined threshold, tₛ₂; determining the likely mode to be anxious mode if h is less than or equal to tₕ and s is greater than tₛ₂; determining it to be non-anxious mode if h is less than or equal to tₕ but s is less than or equal to tₛ₂; playing predetermined soothing music on the device or on a separate remote speaker near the user if the likely mode is anxious mode; and do nothing otherwise.

It will be understood by persons of ordinary skills in the art that classification tree methods can be applied to embodiments with more than two predetermined possible modes or more than two collected information items or both. It will also be understood by persons of ordinary skills in the art that classification tree methods can be complex when there are many collected information items or many predetermined possible modes. For example, the decisions at some nodes of the tree can involve more than one collected information item and can involve complicated mathematical operations. This exemplary embodiment shows that classification tree or other methods can be used instead of Naïve Bayes classification method. It will be understood by persons of ordinary skills in the art that effectiveness of a classification method depends on many factors, including the exact definition of effectiveness, the particular implementation of the method, quality of training dataset if training is required, and the specific classification problem that a classification method is being applied to. Thus, it can be not very meaningful to claim which method is best in general before considering all those factors. This disclosure does not designate preferred embodiments for the same reason.

### Overview of Some Exemplary Embodiments of User Need Estimation on Mobile Device and its Applications

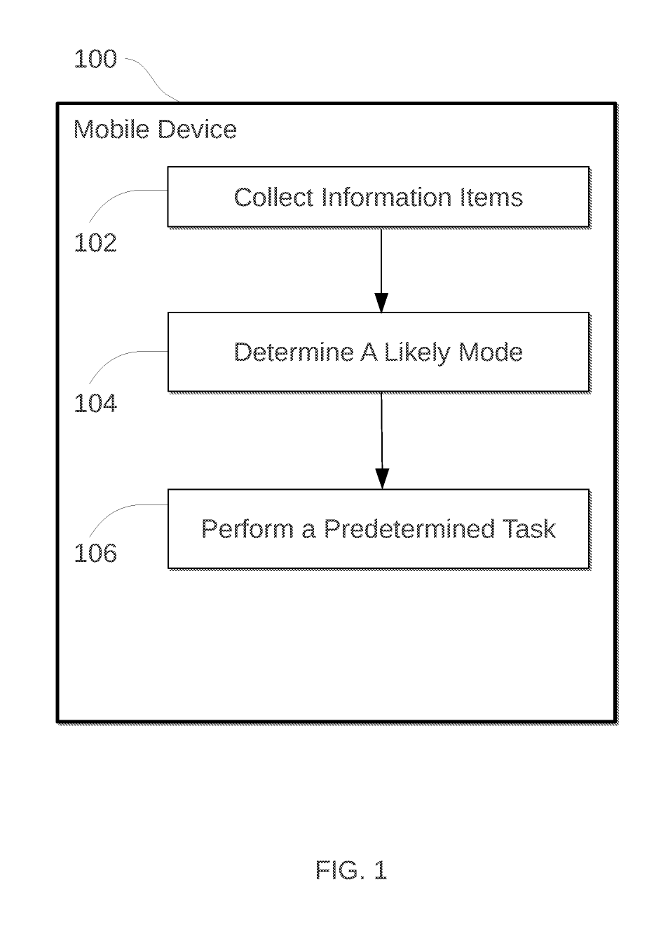

FIG. 1 is a block diagram providing an overview of some exemplary embodiments of user need estimation on mobile device and its applications.

Mobile device 100 can collect 102 a plurality of information items on device 100 at or around a given time. Mobile device 100 can be a single mobile device, or a group of two or more communicatively connected mobile or non-mobile devices with at least one of them being a mobile device. In this disclosure, information item can mean anything which can contain information. Collecting an information item can mean determining the content or information within an observation of the information item. Exemplary collection of an information item includes determining a numerical or symbolic value that represents an observation or observed state of the information item at a specific time. Around a given time in this disclosure means within certain amount of time from the given time, either before or after the given time. The amount can be less than several minutes, e. g. 10 minutes, as a person's mental or physical activities can change rapidly. Since people often follow a calendar, a sleep-wake or some other cycle in their activities, in some exemplary embodiments, the given time itself, length of time from the start of a calendar year to the given time, length of time from the start of a calendar month to the given time, length of time from the start or end of any time interval to the given time, or length of time from the given time to the start or end of any time interval can be an information item being collected. For example, time in the day (i.e. length of time from the start of the calendar day which the given time is in, to the given time) can be such an information item.

When device 100 is a single mobile device, the plurality of information items collected in 102 on device 100 can comprise at least two items from one or more categories of information items described below. Category I includes items about status or state of device 100, and information stored on device 100, such as whether or not a phone call is ongoing or recently completed on device 100, phone numbers involved in the phone call if one is ongoing or recently completed, contact information stored on device 100 associated with those phone numbers, whether or not a touch input, an audio input or any other form of input from the person is being received or was recently received on device 100, one or more readings of an accelerometer on device 100 or related statistics, one or more readings by a gyroscope or an equivalent sensor on device 100 or related statistics, orientation and positioning of device 100, whether device 100 is being charged, status of a battery on device 100, or others. Recent or recently in this context means less than a few minutes ago, e. g. 10 minutes. Related statistics of some measurement or quantity in this context refer to one or more of the following: mean (or average), median, standard deviation, mode, weighted average or other statistics calculated using a set of such measurements or quantities. Category II includes items about the surroundings or environment of device 100, or relation between device 100 and its environment, that may contain information about the person's current or recent activities. Examples include: the geographic location of device 100, the speed of device 100 relative to a given reference system (e. g. the ground) at a time instant or averaged over a time interval, the sound level measured by an acoustic-to-electric transducer or sensor on device 100 or related statistics, identification information of wireless signal emitters whose signals can be detected on device 100 (e. g. cell towers, wireless routers, and navigation satellites) or strengths of their detected signals, measurement of magnitude or direction of an external electric, magnetic, or electromagnetic field by a capable sensor on device 100 or related statistics, ambient air temperature measured by a thermometer on device 100 or related statistics, ambient air pressure measured by a barometer on device 100 or related statistics, ambient air humidity level measured by a capable sensor on device 100 or related statistics, pressure exerted on a component of device 100 or related statistics, luminance as measured by a photoelectric sensor on device 100 or related statistics, the intensity of an ionizing radiation measured by a capable sensor on device 100 or related statistics (e. g. by a Geiger counter), ambient concentration of a particular chemical element or compound (e. g. carbon dioxide) measured by a capable sensor on device 100 or related statistics, or the like. Speed of device 100 can be estimated or determined by using two or more geographic location estimates of device 100 at different times and methods for doing so are well known to persons of ordinary skills in the art. Geographic location estimates of device 100 can be provided by navigation satellite signal receiver, or other capable sensors or systems. Category III includes information items related to physiological measurements of a person, recorded on device 100 through either contact or non-contact means, such as heart rate or related statistics, body temperature or related statistics, blood glucose concentration or related statistics, or the like. It will be understood by persons of ordinary skills in the art that the exemplary information items listed above are not exhaustive. Other information items containing information about the person's current or recent activities can also be collected on device 100 in 102.

When device 100 is a group of two or more communicatively connected mobile or non-mobile devices with at least one of them being a mobile device, close physical proximity to device 100 can mean close physical proximity to a mobile device in the group and the plurality of information items collected in 102 can include information items described above that are related to, applicable to, or collected on one mobile or non-mobile device within the group, such as geographic location of a mobile device within the group, heart rate of a person recorded on a portable sensor within the group, or sound level detected on a non-mobile device within the group.

It will be understood by people of ordinary skills in the art that the choice of information items can be important in constructing an effective embodiment of user need estimation on mobile device and its applications. Some information items can be irrelevant or redundant in a specific embodiment. Choosing only revelant information items can reduce the number of information items collected and used in an embodiment while maintaining acceptable mode estimation accuracy. The selection of information items can be considered in the context of feature selection in a general classification problem. Several methods are well known in the art for feature selection for general classification problems. For example, an article titled “Feature Selection for Classification” by Manoranjan Dash and Huan Liu published in the journal Intelligent Data Analysis (vol. 1, no. 1-4, pp. 131-156, 1997) provided an overview of some methods of feature selection for general classification problems. Persons of ordinary skills in the art can apply one of the methods known in the art to a specific embodiment to select information items to be collected in 102 according to specific performance criteria or an evaluation function. In exemplary embodiments described in this disclosure, as the object being classified is a person's activities, information items can also be selected based on common understanding of their relevance to his activities in a particular embodiment, his habits and lifestyle, in addition to or instead of any known feature selection method in the art. In practice, such selection can further be dependent on the type of sensors available on a particular device and quality of sensor (i.e. how the sensor's readings differ from the true values they are trying to measure).

For example, in an exemplary embodiment, there can be two and only two predetermined possible modes of the activities of a person in close physical proximity to a mobile device at any time: sleeping mode and wakeful mode. The person follows a daily sleep-wake cycle. Time in the day could contain information about his activities at a given time. Sound level detected on device 100, if sufficiently accurate, could also be relevant as people are more likely to sleep in a quiet environment than in a noisy one. Geographic location of device 100, if sufficiently precise, could be relevant as well, as people are more likely to sleep among a limited number of places, such as homes, mobile homes, hotels, friends' homes, hospitals, or camping sites, and are less likely to sleep at a restaurant, sports stadium, construction site, school or market. Heart rate, when measured sufficiently accurately, could be relevant too as its likely range can change between sleeping and wakeful mode. However, status of a battery on device 100, even accurately measured, can be less relevant since the same battery status can be equally likely to occur in sleeping mode as it is in wakeful mode. Thus, time in the day, sound level, geographic location or heart rate can be selected as one of the information items to be collected in 102 in this embodiment.

An information item almost always takes time to collect. For example, when collecting the geographic location of device 100, there usually can be a delay between the start of collection (i. e. requesting a geographical location) and the completion of the collection (i. e. the requested geographic location is obtained on device 100). When collecting more than one information item, different items often take varying amounts of time and those amounts may not be known for certain before the collection's completion. Collection of different information items may or may not begin at the same time and may or may not end at the same time. In some exemplary embodiments, collection of all information items can be completed at or around given time.

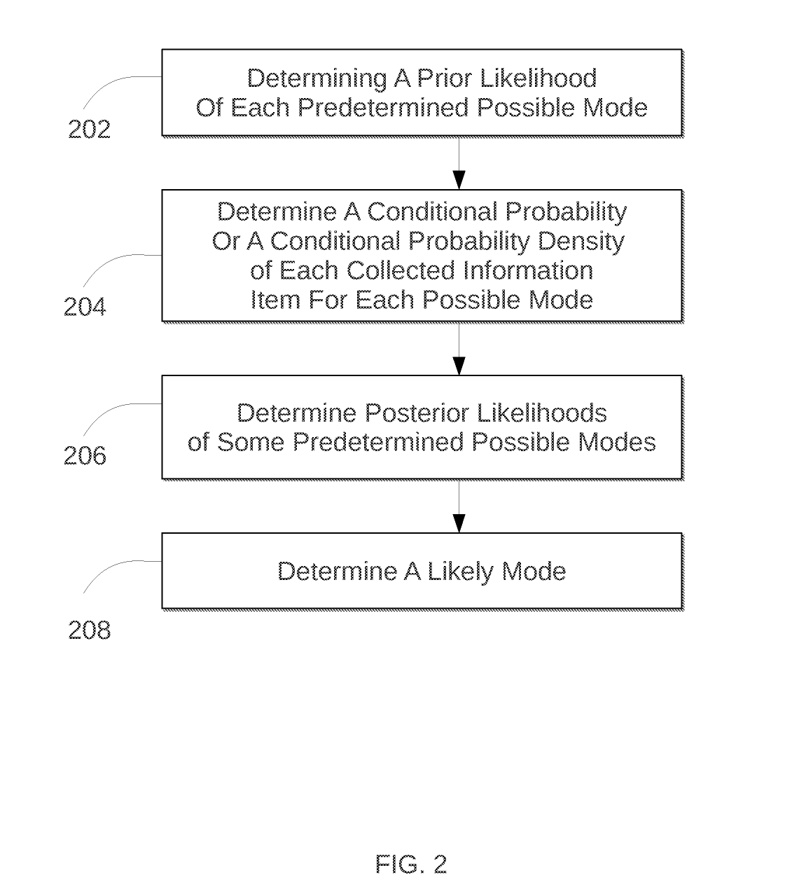

Device 100 can determine 104, using the collected information items, a likely mode. More specifically, device 100 can determine 104, using the collected information items, a likely mode of the activities of a person who at given time is in close physical proximity to device 100, the likely mode being one or more modes among a plurality of predetermined possible modes. The person can be referred to as a user of device 100, even if it may mean device 100 has more than one user. Determination of the likely mode in 104 can be referred to as user mode estimation, in accordance with the discussions before. Further details of an exemplary process of user mode estimation using a Naïve Bayes classification method will be discussed below in reference to FIG. 2.

In some exemplary embodiments, the plurality of predetermined possible modes can contain two or more sets of modes. Modes in each set can be mutually exclusive. For example, the plurality of predetermined possible modes can include sleeping mode, wakeful-not-working, wakeful-working mode, anxious mode and not-anxious mode. Sleep mode, wakeful-not-working mode, and wakeful-working mode can form a set of mutually exclusive modes. Anxious mode and not-anxious mode can form the second set of mutual exclusive modes. A set can be comprehensive or not comprehensive.

Device 100 can perform 106 a predetermined task, in response to the likely mode or intermediate results of the determination in 104. The predetermined task is related to one or more needs implied by the likely mode. Step 106 can start before or after the determination in 104 is completed.

In some exemplary embodiments, the predetermined task can be any task that can enable device 100 or another apparatus to provide a more personalized and possibly more satisfying user experience to the user based on one or more needs implied by the likely mode. In some exemplary embodiments, the predetermined task can be any task that can enable device 100 or a different apparatus to more efficiently utilize available resources, such as computing, memory, power and communications resources based on one or more needs implied by the likely mode. Exemplary tasks include: shutdown of a computer program or a feature of a computer program running on device 100 that is irrelevant or contrary to the needs implied by the likely mode; starting a relevant computer program or feature of a computer program on device 100 that is relevant or helpful to the implied needs; switching a computer program running on device 100 from one operation mode to a different operation mode; switching device 100 from one configuration, to a different configuration; enabling a component of device 100; disabling a component of device 100; switching a component of device 100 from one operation mode to a different operation mode; setting up a scheduled task on device 100; postponing a scheduled task on device 100; canceling a scheduled task on device 100; causing a different computing device to perform a different predetermined task; or causing a different apparatus to perform a different predetermined task.

In some exemplary embodiments, the predetermined task can be switching device 100 to a predetermined configuration associated with the likely mode determined in 104. A predetermined configuration can mean a predetermined set of instructions or setting of device 100. In some exemplary embodiments, one exemplary configuration associated with sleeping mode can be described as below. When operating in this configuration, device 100 will perform one or more of the following: shutting down any visual gaming program still running on device 100 and prevent any other visual gaming program or application from launching; preventing any program or application from presenting a user interface; starting a predetermined sleeping quality detection program on device 100 if it is not already running; starting a power conservation feature of its power management program if it is not already running; switching an operation system program running from normal mode to a different, more power-efficient mode if the program is running in normal mode; disabling certain sensors on device 100, such as an accelerometer, and reconfigure the device to run without those sensors if they are not already disabled; enabling some sensors, such as an acoustic-to-electric sensor, if those sensors are not already enabled; switching one or more processors on device 100 from normal mode to a different, more power-efficient mode; postponing a scheduled software update alert; muting a speaker or vibrator of device 100; and suppressing all alerts or warnings that are not critical.

In some exemplary embodiments, one exemplary configuration associated with driving mode can be described as follows. When operating in this configuration, device 100 will perform one or more of the following: sending incoming phone calls from certain phone numbers, or those that are not certain phone numbers, directly to voicemail without alerting the user; estimating its current geographic location, requesting nearby road traffic information from a different remote server, receiving that information and displaying it on device 100 or on a display screen of a vehicle automatically without user's direct attention; requesting prices of motor fuel around estimated geographic location from a remote server and processing them for display to the user; and estimating its ground speed and requesting speed limit information about the current road device 100 is on to make a comparison.

In some exemplary embodiments, the predetermined task can include device 100 sending data or commands over a communications network to a different remote computing device or apparatus to cause it to perform another predetermined task. In some exemplary embodiments, the predetermined task can be device 100 sending a command over a local wireless area network to a predetermined appliance to cause it to shutdown or enter a power-conservation mode. In some exemplary embodiments, the predetermined task can be device 100 sending a command over a wireless network to cause some predetermined light fixtures capable of receiving such command in a building to turn off. In some exemplary embodiments, the predetermined task can be device 100 sending a command over a wireless network to a connected home security system to cause it to operate. In some exemplary embodiments, the predetermined task can be device 100 sending a command over a wireless network to some connected personal computers to cause them to shutdown to conserve power or start up to prepare for usage. In some exemplary embodiments, the predetermined task can be device 100 sending data or a command over a communications network to a remote ad server to cause it to perform a predetermined task, such as selecting or creating one or more ads and transmitting them to an advertising platform to be exposed to a person. In some exemplary embodiments, device 100 can send messages over a communications network to a predetermined group of mobile devices or servers, notifying them the likely mode of the person determined in 104.

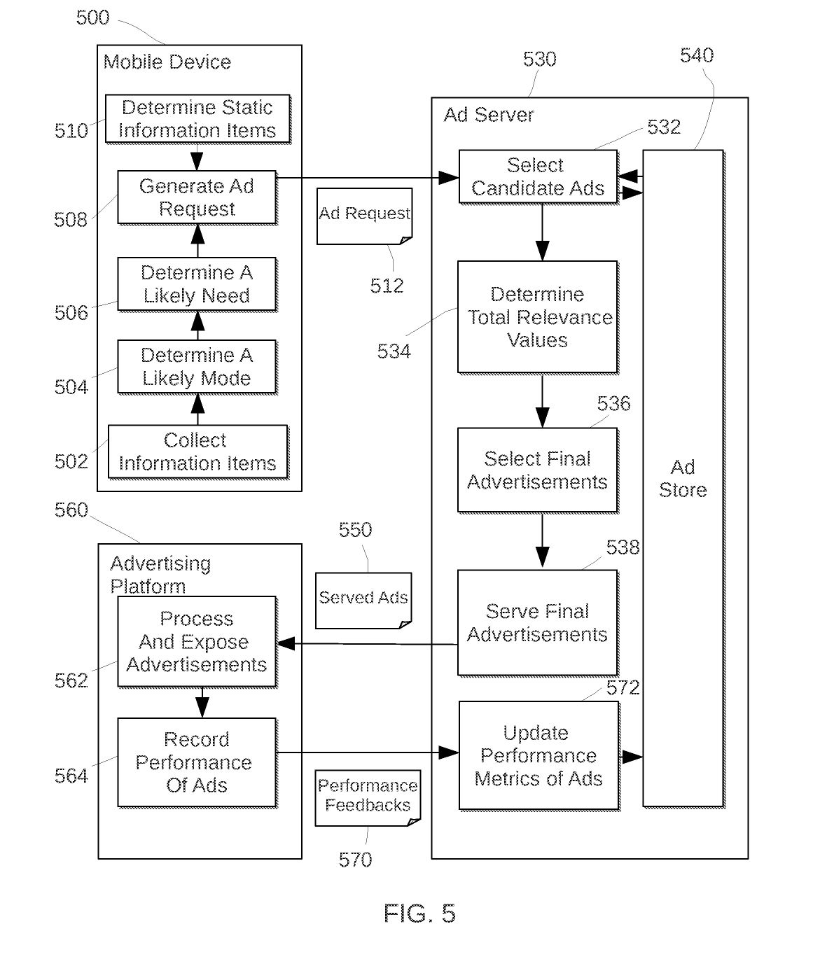

When the predetermined task is device 100 sending data or a command over a communications network to a remote ad server to cause it to select or create one or more ads and transmit them to an advertising platform, corresponding embodiments can also be considered embodiments of advertising based on user need estimation on mobile device. Exemplary techniques of advertising based on user need estimation on mobile device will be discussed in details below in reference to FIG. 5.

It will be understood by persons of ordinary skills in the art that the details of exemplary predetermined tasks above are described for illustrative purpose only. In an embodiment, persons of ordinary skills in the art can determine a specific task for a given likely mode of a given user, based on needs implied by the likely mode. In some exemplary embodiments, the user can specify a task associated with any predetermined possible mode herself and set the device to automatically perform the task once the likely mode determined in 104 contains that mode.

### User Mode Estimation Using a Naïve Bayes Classification Method

FIG. 2 is a flowchart of an exemplary process for user mode estimation using a Naïve Bayes classification method.

Device 100 can determine 202 a prior likelihood for each predetermined possible mode at a given time. Likelihood and probability are used interchangably in this disclosure and mean the same thing. A prior likelihood of a mode can be the likelihood that a user of device 100 is in that mode, before considering any information item collected on device 100 at or around the given time. This definition of prior likelihood is consistent with its most widely used definition in the art. In some exemplary embodiments, prior likelihood of a mode can be a numeric value between 0 and 1, inclusive of both 0 and 1. In some exemplary embodiments, all possible modes can have equal prior likelihoods (i. e. the prior likelihood of any mode can be a numeric value equal to 1 divided by the total number of all possible modes that the user can be in at that time). In some exemplary embodiments, the prior likelihood of a mode can reflect only prior information about the user, and can contain no information about device 100 itself, nor any information items previously collected on device 100. In some exemplary embodiments, the prior likelihood of a mode can reflect information items previously collected on device 100. In some exemplary embodiments where the time for which the user mode is estimated is known before step 202, prior likelihoods can take time into account. Thus, in those embodiments, the prior likelihood of the same mode of the same user can be different at different times. In some exemplary embodiments, prior likelihoods can be time independent (i. e. prior likelihood of the same mode of the same user can be a constant regardless of time).

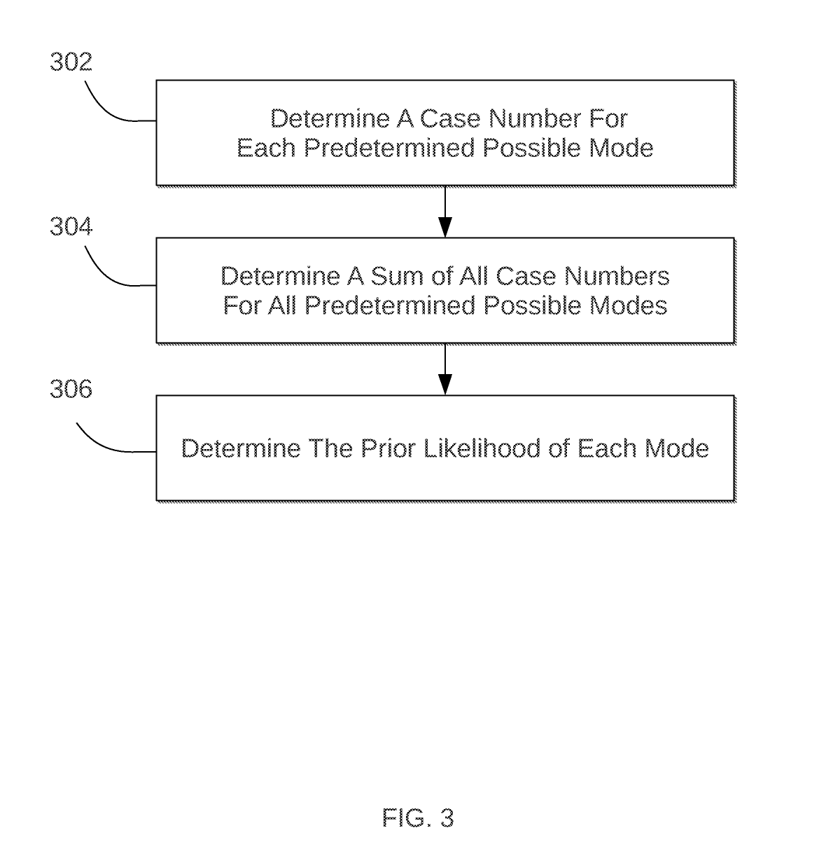

The prior likelihoods can be stored persistently on a non-transitory storage medium on device 100 or remotely on a different computing device, and can be retrieved in 202. In some exemplary embodiments, they are determined by device 100 based on information or data retrieved from a storage medium on device 100 or received from a different computing device over a communications network. In some exemplary embodiments, the prior likelihood for each predetermined possible mode can be determined to be a constant, which equals to 1 divided by the number of all predetermined possible modes the user can be in at the given time. Further details of an exemplary prior likelihood determination process will be discussed below in reference to FIG. 3.

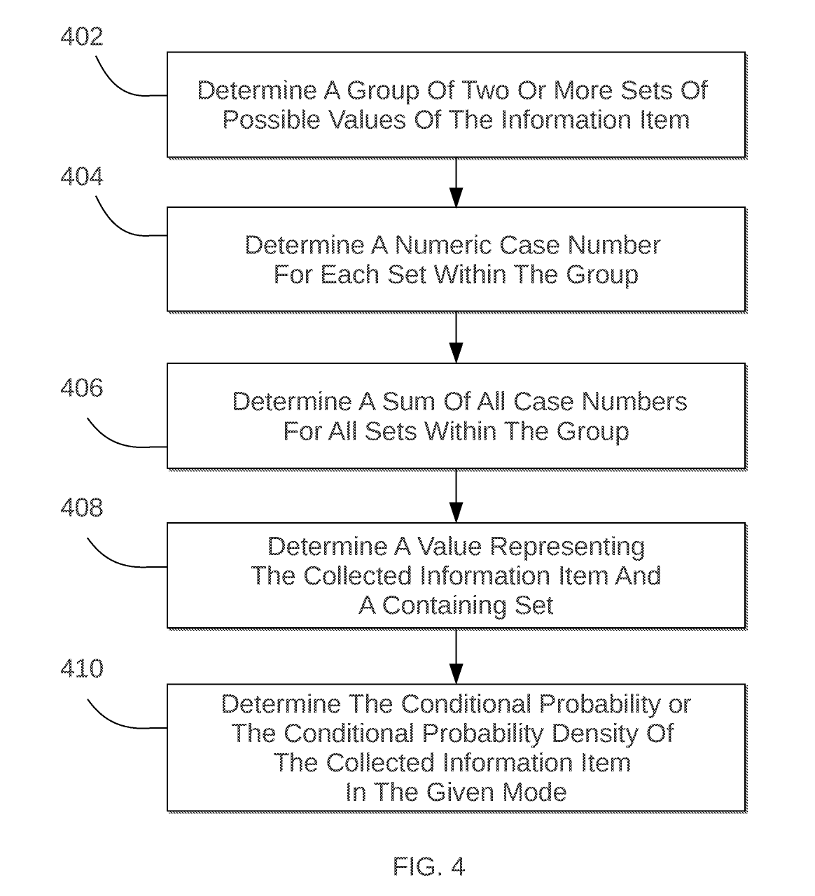

Device 100 can determine 204 a conditional probability or conditional probability density of each collected information item for each possible mode. The conditional probability or conditional probability density of a collected information item for a possible mode can mean the probability or probability density that the information item being collected takes the specific value or content as collected, when the user is in that mode, at the given time. It can be dependent on the information item being collected, the definition, scope or boundaries of the mode, the user, the given time, sensors on device 100 used to collect the information item, and the way the information item is being collected on device 100. Conditional probability or conditional probability density are always non-negative real numbers. The mapping from possible values or contents of an information item, to their corresponding conditional probability or conditional probability density for a possible mode, at a given time, can be referred to as conditional probability function or conditional probability density function of that information item for that mode at the given time. This is consistent with most widely used definition of conditional probability function or conditional probability density function that is well known to persons of ordinary skills in the art. In an exemplary embodiment, the conditional probability function of a sound level measured on device 100 for sleeping mode at a given time can be different from that of the sound level for wakeful mode at the same time. In another exemplary embodiment, the conditional probability density function of geographic location of a first mobile device for a working mode at a given time can be different from that of geographic location of a second mobile device for the same or different working mode at the same time, especially when those two devices' users do not share the same work location. Further details of an exemplary process of determining a conditional probability or a conditional probability density of a collected information item in a given mode will be described below in reference to FIG. 4.

Device 100 can determine 206 posterior likelihoods of one or more predetermined possible modes, using the prior likelihoods of all possible modes as determined in 202 and the conditional probabilities or conditional probability densities as determined in 204.

A posterior likelihood of a mode can be a likelihood that the user is in that mode at given time, after considering one or more of the information items collected on device 100 at or around that time. In some exemplary embodiments, the process of determining the posterior likelihood of a possible mode can be based on Bayes' theorem and an assumption that all information items are independent from each other, in a probability sense. In an exemplary embodiment, an exemplary process of 206 can be described as follows. The user can be in one and only one of two mutually exclusive predetermined possible modes: sleeping mode and wakeful mode, at the given time. Two information items, a sound level detected on device 100 and the given time, are collected at or around the given time. A prior likelihood of sleeping mode can be determined to be p₁ based on the given time. A prior likelihood of wakeful mode can be determined to be p₂=1−p₁. The sound level is measured to be s, a real number. A conditional probability of the sound level being s for sleeping mode can be determined to be c₁. A conditional probability of the sound level being s for wakeful mode can be determined to be c₂. A posterior likelihood of sleeping mode q₁ can be determined to be

$${q}_{1} = \frac{{p}_{1} \times {c}_{1}}{( {p}_{1} \times {c}_{1} + {p}_{2} \times {c}_{2} )} .$$

A posterior likelihood of wakeful mode can be determined to be q₂=1−q₁.

In another exemplary embodiment, an exemplary process of 206 can be described as follows. The user can be in one and only one of two mutually exclusive modes: sleeping mode and wakeful mode, at the given time. Two information items, a sound level detected on device 100 and a magnitude of a linear acceleration of device 100 measured by an accelerometer on device 100, are collected around the given time. A prior likelihood of sleeping mode can be determined to be p₁. A prior likelihood of wakeful mode can be determined to be p₂=1−p₁. The sound level is measured to be s. A conditional probability of sound level being s for sleeping mode can be determined to be c₁. A conditional probability of sound level being s for wakeful mode can be determined to be c₂. The magnitude of the linear acceleration of device 100 can be measured to be a. A conditional probability of the magnitude being a for sleeping mode can be determined to be d₁. A conditional probability of the magnitude being a for wakeful mode can be determined to be d₂. Posterior likelihoods of sleeping mode and wakeful mode can be determined as follows. The posterior likelihood of sleeping mode can be determined to be

$${q}_{1} = \frac{{p}_{1} \times {c}_{1} \times {d}_{1}}{( {p}_{1} \times {c}_{1} \times {d}_{1} + {p}_{2} \times {c}_{2} \times {d}_{2} )} .$$

The posterior likelihood of wakeful mode can be determined to be q₂=1−q₁.

In some exemplary embodiments, the number of predetermined possible modes can be greater than two. In one such embodiment, one exemplary process of 206 can be described as follows. The user can be in one and only one of three mutually exclusive modes at the given time: sleeping mode, wakeful-working mode and wakeful-not-working mode. A prior likelihood of sleeping mode at the time can be determined to be p₁. A prior likelihood of wakeful-working mode at the time can be determined to be p₂. A prior likelihood of wakeful-not-working mode at the time can be determined to be p₃=1−p₁−p₂. Two information items, a sound level detected on device 100 and the geographic location of device 100, can be collected at or around the given time. The sound level is measured to be s. A conditional probability of the sound level being s for sleeping mode can be determined to be c₁. A conditional probability of the sound level being s for wakeful-working mode can be determined to be c₂. A conditional probability of the sound level being s for wakeful-not-working mode can be determined to be c₃. The geographic location of device 100 can be determined to be g. g can be any geographic object. A geographic object can be a geographic point, geographic area, or a union (or intersection) of a finite collection of geographic points or geographic areas. A geographic point or area can be a point or area on Earth that can be uniquely and clearly defined to a person with ordinary skills in the art. A conditional probability density of the geographic location being g for sleeping mode can be determined to be d₁. A conditional probability density of the geographic location being g for wakeful-working mode can be determined to be d₂. A conditional probability density of the geographic location being g for wakeful-not-working mode can be determined to be d₃.

The conditional probability density d₁ can be determined based on an estimated distance x₁ between g and another geographic object indicating places where she can usually be located while in sleeping mode, such as her home, apartment, frequently visited hotels, or the like. Likewise, the conditional probability density d₂ can be determined based on an estimated distance x₂ between g and another geographic object indicating places where she can usually be located when she is in wakeful-working mode, such as her workplace. The conditional probability density d₃ can be determined based on an estimated distance x₃ between g and another geographic object indicating places where she can usually be located when she is in wakeful-not-working mode, such as her home, the neighborhood of her home and other places she frequently visits while in that mode. Those conditional probabilities density can be determined using a Gaussian (or normal) distribution function with respect to the corresponding estimated distances. For example,

$${d}_{1} = \frac{1}{{σ}_{1} \sqrt{2 π}} {e}^{- \frac{{x}_{1}^{2}}{2 {σ}_{1}^{2}}}$$

where σ₁ is a predetermined positive constant, e is the base of natural logarithm. They can also be determined using other distribution functions known in the art with respect to the corresponding estimated distances.

Distance between two geographic objects can have varying definitions. For example, it can be defined to be the minimum geographical distance between any two geographic points in the two geographic objects. Alternatively, it can be defined to be the maximum distance between any two geographic points in the two geographic objects. Various definitions of geographical distance between two geographic points exist in the art as well, such as a first one that is using great circle distance of two points on the Earth and assuming the Earth to be spherical with a known radius, or a second one assuming the Earth to be ellipsoidal. Any one can be used in a particular embodiment.

A posterior likelihood of sleeping mode q₁ can be determined to be

$${q}_{1} = \frac{{p}_{1} \times {c}_{1} \times {d}_{1}}{( {p}_{1} \times {c}_{1} \times {d}_{1} + {p}_{2} \times {c}_{2} \times {d}_{2} + {p}_{3} \times {c}_{3} \times {d}_{3} )} .$$

A posterior likelihood of wakeful-working mode q₂ can be determined to be

$${q}_{2} = \frac{{p}_{2} \times {c}_{2} \times {d}_{2}}{( {p}_{1} \times {c}_{1} \times {d}_{1} + {p}_{2} \times {c}_{2} \times {d}_{2} + {p}_{3} \times {c}_{3} \times {d}_{3} )} .$$

A posterior likelihood of wakeful-not-working mode can be determined to be q₃=1−q₁−q₂.

In some exemplary embodiments, the number of all predetermined possible modes can be greater than three and the number of information items collected in 102 can be greater than two. It will be understood by persons of ordinary skills in the art that for those embodiments, step 206 can be performed by applying Bayes' theorem to all possible modes using all information items in a way similar to the techniques in the exemplary embodiments described above. It will also be understood by persons of ordinary skills in the art that variations to the implementation of Bayes' theorem as described above can also be used to obtain posterior likelihoods of possible modes. In some exemplary embodiments, rounding of a real number into another real number that can be represented by binary digits with finite length can occur at any step of applying Bayes' theorem, when the calculations in that step are implemented on a digital computer with finite word length. In some exemplary embodiments, some mathematical operations, such as adding or multiplying a numeric value to one or more operands in any part of any calculation in a Naïve Bayes classification method, can be performed, in addition to those calculations required by Naïve Bayes classification method to obtain posterior likelihoods. The posterior likelihoods obtained from those variations may or may not be equal or close to, the posterior likelihoods obtained theoretically using a strict implementation of Naïve Bayes classification method. But they can still be useful in user mode estimation.

In those embodiments where more than one sets of modes exist in the plurality of predetermined possible modes, when applying a Naïve Bayes classification method, the method is applied to each set of modes separately and independently, just as if the other set does not exist.

Device 100 can determine 208 a likely mode, based on posterior likelihoods of one or more predetermined possible modes as determined in 206. In some exemplary embodiments, device 100 can determine the likely mode to be the one with highest posterior likelihood among all modes within one set of predetermined possible modes. In some exemplary embodiments where there are more than one comprehensive sets of modes within the plurality of predetermined possible modes, device 100 can determine the likely mode to include the mode with highest posterior likelihood within each set. In some exemplary embodiments, device 100 can estimate the likely mode to be the ones whose posterior likelihoods exceed a predetermined threshold, e. g. 0.5.

### Prior Likelihood

FIG. 3 is a flowchart of an exemplary process for determining a prior likelihood of each predetermined possible mode at a given time.

Device 100 can determine 302 a case number for each predetermined possible mode. In some exemplary embodiments, the case number for each mode can be predetermined and stored on a non-transitory storage medium on device 100 or remotely on a different device before step 300. Device 100 can determine the case number for each mode by retrieving it from the storage medium on device 100 or over a communications network, respectively.

In some exemplary embodiments, the case number for each mode can be determined based on a training data set. Each data in the training data set contains a plurality of collected information items and corresponding mode, which can be one or more predetermined possible modes. The case number for a predetermined possible mode can be determined to be the number of occurrences of that mode in the training data set. In some exemplary embodiments, the case number for each mode can be determined using information provided by a user of device 100, such as the user's answer to questions about his lifestyle. For example, the user can be asked “how often do you sleep at 9 a.m. Sunday?” An answer of “very often” can result in case number 85 for sleeping mode and 15 for wakeful mode at 9 a.m. Sunday. “somewhat often” can result in 60 for sleeping mode and 40 for wakeful mode at that time. “once a while” can result in 20 for sleeping mode and 80 for wakeful mode. “not at all” can result in 1 for sleeping mode and 99 for wakeful mode. In some exemplary embodiments, the case number for each mode can be calculated based on information about the user that is available on device 100 or on other connected computing devices, such as the user's calendar, appointment planner, call logs, audio or video recordings on device 100, or the like, which provides some information about her activities. For example, device 100 can look through a well maintained user calendar to determine the number of times during previous calendar year that the user had something scheduled at 10 a.m. Monday by examining her entries. That number can be used as case number for wakeful mode at 10 a.m. Monday.

In some exemplary embodiments, the case number for each mode can be required to be a positive integer to avoid zero prior likelihood for some mode. In some exemplary embodiments, the case number associated with the same mode can be different at different times. For example, the case number for each mode can be stored on device 100 and be incremented each time when the likely mode determined contains that mode (i. e. the user is estimated to be in that mode then).

Device 100 can determine 304 a sum of all case numbers for all predetermined possible modes.

Device 100 can determine 306 the prior likelihood of each mode to be the result of dividing the case number for the mode by the sum.

### Conditional Probability

FIG. 4 is a flowchart of an exemplary process of determining a conditional probability or a conditional probability density of a collected information item in a given mode.

Device 100 can determine 402 a group of two or more sets of possible values of the information item being collected. In an exemplary embodiment, the information item is a sound level detected and measured by a digital acoustic-to-electric transducer or sensor on device 100 and its possible values are integers 0 from to 65,535 (2¹⁶-1). In the exemplary embodiment, an exemplary group of sets of possible values of the sound level can be: a first set containing integers ranging from 0 to 5,000, a second set ranging from 5,001 to 15,000, a third set ranging from 15,001 to 30,000, a fourth set ranging from 30,001 to 45,000, a fifth set ranging from 45,001 to 65,535.

Device 100 can determine 404 a numeric case number for each set within the group. In the exemplary embodiment described in the paragraph above, the case number for each set within the exemplary group can be determined to be: 30 for the first set, 35 for the second set, 20 for the third set, 10 for the fourth set, 5 for the fifth set.

In some exemplary embodiments, the case number for each set within the group can be required to be a positive integer to avoid zero conditional probability or conditional probability density for some collected information items. In some exemplary embodiments, device 100 can retrieve the case number from a non-transitory storage medium on device 100 or remotely from a different device over a communications network. In some exemplary embodiments, the case number for each set within the group can be determined by a training process performed on device 100 beforehand. One exemplary such process can be described as follows. Device 100 can collect the information item repeatedly, for a given number of times, when the user is known to be in the given mode. Device 100 can then generate a group of values with each value represents one collected information item. For each set within the group, device 100 can then determine the number of times those values fall into that set. Device 100 can then determine the case number associated with each set to be the corresponding number. In some exemplary embodiments where a training set of training data is provided, the case number can be the number of training data in the training set that is both classified into the mode and has its collected information item value falls in the set.

Device 100 can determine 406 a sum of all case numbers for all sets within the group. In the exemplary embodiment described above, the sum can be determined to be 100.

Device 100 can determine 408 a value representing the collected information item among all possible values of the information item and a containing set within the group to which it belongs. In the exemplary embodiment described above, the value can be determined to be 25,100 and the containing set to which it belongs can be determined to be the third set.

Device 100 can determine 410 the conditional probability or the conditional probability density of the collected information item in the given mode to be the product of the numeric case number for that containing set and multiplicative inverse of the sum. In the exemplary embodiment described above, the conditional probability density can be determined to be 0.2.

Though an information item with numeric value is used in the example of conditional probability density determination above, it will be understood by persons of ordinary skills in the art that conditional probability or conditional probability density can be determined in similar steps for an information item with a non-numerical value, such as discrete symbolic values.

It will be understood by persons of ordinary skills in the art that conditional probability or probability density can be determined using analytical methods based on mathematical formula with closed form, if needed. In some exemplary embodiments, a mathematical model, such as a Gaussian distribution model or Poisson model, can be used to calculate conditional probability or conditional probability density that an information item has a specific value when the user is in a given mode and the parameters in those models can be determined based on data in training set or other means.

### Advertising Based on User Need Estimation on Mobile Device

FIG. 5 is a diagram illustrating exemplary techniques of advertising based on user need estimation on mobile device.

UTC in this disclosure refers to Coordinated Universal Time. URL refers to Uniform Resource Locator. JSON refers to JavaScript Object Notation. XML refers to Extensible Markup Language. Hour, minute and second in a day can be represented as HH:MM:SS, where HH is a two digit representation of the hour, ranging from 00 to 23, MM a two digit representation of minute in a hour, ranging from 00 to 59, and SS a two digit representation of second in a minute, ranging from 00 to 60 considering leap second. UNIX refers to UNIX operating system. The meanings of those words, concepts or definitions above are well known to persons with ordinary skills in the art.

Two exemplary groups of embodiments, group one and group two, and other embodiments outside those two groups will be described below, along a general description of exemplary techniques of advertising based on user need estimation on mobile device. Exemplary embodiment A within group one and exemplary embodiment B within group two will be discussed in detail using exemplary information items, their exemplary collected values, exemplary user modes, and exemplary ads. It will be understood by persons of ordinary skills in the art that they are provided for illustrative purpose only. Other information items, other collected values of the exemplary information items, other user modes, and other ads can be used or occur as well. Other embodiments within group one and group two, as well as outside them, can also be implemented and practiced.

Device 500 can collect 502 information items, at or around a given time. Device 500 can be same as device 100 described in reference to FIG. 1. 502 can be the same step as 102 described in reference to FIG. 1. In both embodiment A and B, information items collected in step 502 at any given time can include: the given time (referred to as mode time below as it is the time for which estimated user mode is applicable), time zone in which device 500 is located (referred to as time zone below), geographic location of device 500 (referred to as device location below), speed of device 500 relative to ground, sound level detected on device 500 and a standard deviation of 20 readings of an accelerometer on device 500 during 4 seconds that is centered at the given time. For example, at or around an exemplary given time 2014-09-09 15:00:00 UTC, exemplary collected information items can be as follows: mode time can be determined to be 2014-09-09 15:00:00 UTC or UNIX time 1410274800, time zone can be estimated to be eastern daylight time, or UTC-04:00, device location can be determined to be at 35.917 degrees latitude and −79,046 degrees longitude, speed of device 500 can be determined to be 2.5 meters per second, and the standard deviation is determined to be 0.6 meter per second squared.

Device 500 can determine 504 a likely mode. More specifically, device 500 can determine 504, using the collected information items as collected in 502, the likely mode of the activities of a person who at the given time is in close physical proximity to device 500. The likely mode is one or more modes among a plurality of predetermined possible modes. In some exemplary embodiments, 504 can be the same as 104 described in reference to FIG. 1. In some exemplary embodiments, 504 can contain only parts of step 104. Yet in some other exemplary embodiments, 504 can be skipped completely with all necessary inputs to 504 being included in ad request 512 and an equivalent step of 504 is performed on ad server 530 to determine a likely mode.

In both embodiment A and B, the predetermined possible modes can include two comprehensive groups of modes that are independent from each other. The first such group can include stationary mode, walking mode, running mode, biking mode, driving-motorized-ground-vehicle mode, flying mode, and other-type-of-moving mode. The second such group can include sleeping mode, working mode, leisure mode, exercising mode, grocery shopping mode, mall shopping mode, and wakeful-others mode. In the second group, wakeful-others mode include those activities of the user when he is awake and also can not be classified into any other mode within the second group. In both embodiment A and B, an exemplary process of 504 can determine, using the exemplary collected information items at the exemplary time, the likely mode of the activities of the user to be biking mode and exercising mode.

Device 500 can determine 506 a likely need. More specifically, device 500 can determine, based on the likely mode determined in 504 or intermediate results of its determination, a likely need of the user. The likely need can be one or more needs among two or more predetermined needs of the user. Each predetermined need can be a need implied by a predetermined possible mode. Each predetermined need can be defined or described by words, phrases or sentences in a natural language and can be determined by experts or the user of device 500 himself. In some exemplary embodiments, the total number of predetermined needs can be finite or limited. In some exemplary embodiments, a predetermined correspondence between the predetermined possible modes and the predetermined needs can be stored on device 500 and be used in 506 to determine the likely need. Device 500 can determine the likely need to be those needs that correspond to the modes in the likely mode.

For example, in embodiment A and B, an exemplary collection of predetermined needs of the user and corresponding numerical codes representing them (i.e. need-codes) can be as follows (the description of each need is quoted and is followed by its need-code in parenthesis): “listen to music” (1), “find reviews and prices for latest consumer electronic devices” (2), “find things on sale at www.amazon.com” (3), “find out weather for next 24 hours” (4), “find out popular attraction sites within 10 miles” (5), “drink some water” (6), “get some coffee, tea or soda” (7), “get some ready-to-eat food” (8), “get a pair of running shoes” (9), “show me running shoes on sale” (10), “buy running outfit” (11), “maintain my bike” (12), “buy a helmet or air pump for my bike” (13), “find a biking trail map” (14), “find a nearby bike repair shop” (15), “find deals or sales on bikes or bike accessories” (16), “find closest operating gas station” (17), “find cheapest gas station within 3 miles” (18), “find out traffic information within 20 miles” (19), “find auto maintenance shops within 10 miles” (20), “get an oil change for my automobile” (21), “get a quote on auto insurance” (22), “find car accessories on sale” (23), “find all hotels within 20 miles that have vacancy tonight” (24), “list best selling books by categories” (25), “list popular movies by categories” (26), “list popular video games” (27), “list popular one person computer games” (28), “turn all incoming calls to voicemail” (29), “wake me up when phone number (123)456-7890 calls” (30), “buy office supplies” (31), “schedule my next vacation” (32), “manage my savings” (33), “find out investment choices” (34), “find sports events next week” (35), “find well-reviewed restaurants by cuisine type” (36), “find inexpensive dining places” (37), “find out dance events nearby” (38), “buy sports shoes” (39), “buy sports clothes” (40), “get energy drinks” (41), “find guides to effective workout” (42), “buy some workout nutrient supplements” (43), “find grocery store coupons” (44), “find what grocery items are on sale nearby” (45), “buy fresh produce” (46), “checkout new types of food items nearby” (47), “find clothes that are in fashion” (48), “find stores that are having a sale” (49), “find clothes on sale” (50), “find electronics store nearby” (51), “find a birthday gift” (52), “find a gift for upcoming holiday” (53), “find clothes both in fashion and on sale” (54), “find museums” (55), “watch popular TV shows” (56), “find trailers of popular movies” (57).

In embodiment A and B, an exemplary correspondence between the exemplary predetermined possible modes and the exemplary predetermined needs can be described as the following: stationary mode corresponds to needs 1, 2, 3; walking mode corresponds to 4, 5, 6, 7, 8; running mode corresponds to 9, 10, 11; biking mode corresponds to 12, 13, 14, 15, 16; driving-motorized-ground-vehicle mode 17, 18, 19, 20, 21, 22, 23, 24; flying mode 25, 26, 27, 28; other-type-of-moving mode 1, 26, 28; sleeping mode 29, 30; working mode 31, 32, 33, 34; leisure mode 35, 36, 37, 38; exercising mode 6, 39, 40, 41, 42, 43; grocery shopping mode 44, 45, 46, 47; mall shopping mode 48, 49, 50, 51; and wakeful-others mode 52, 53, 54, 55, 56, 57.

In embodiment A and B, an exemplary process of 506 can determine, based on the exemplary likely mode being biking mode and exercising mode, an exemplary like need to be needs 6, 12, 13, 14, 15, 16, 39, 40, 41, 42, 43.

Device 500 can collect 510 static information items about device 500, its user, software or hardware. Static information items can include user preferences, user settings, software features or hardware capabilities. They can be constant or infrequently changed throughout the life of device 500, thus can provide little information for user mode estimation purposes. However, they can be very relevant for advertising purposes as they can provide a set of criteria to filter ads, or allow ad server 530 to build an ad request history for device 500 or a group of devices sharing the same attributes as those of device 500. Examples include unique identification information of device 500, whether device 500 has a screen or not, the physical size and pixel density of the screen if it has one, whether device 500 has a built-in speaker or not, or type of ads allowed by its user. For example, in embodiment A and B, two static information items are collected in step 506. The first one is the physical size of a screen of device 500. Based on hardware description of device 500 stored on device 500, the physical size of a screen of device 500 is determined to be 100 mm (or about 4 inches) in diagonal length. The second one is the type of ads allowed by the user of device 500. The user does not allow sexually explicit ads on device 500.

In some exemplary embodiments, static information items collected can be organized in various data structures or formats. In embodiment A and B, one exemplary JSON representation of the two exemplary collected static information items can be {“screen_size”: {“cm”: “10”}, “advertisement_allowed”: {“sexual_explicit”: “false”}}.

Step 510 can be performed independent of steps 502, 504, and 506. 510 can be performed before, during or after any of 502, 504, and 506. In some exemplary embodiments, step 510 is not performed when no static information items can be collected on device 500 or such items are not used by ad server 530.

Device 500 can generate 508 ad request 512. In some exemplary embodiments, ad request 512 can contain one or more data within one or more of the following three data categories. The first data category includes data on the collected information items collected in step 502. The second data category includes data on estimated user needs (i. e. the likely need determined in step 506). The third data category includes data on some or all of the static information items determined in 510. In some exemplary embodiments where step 504 and 506 are skipped, ad request 512 can contain data within data category one, but no data in data category two. In some exemplary embodiments where 504 contains part of 104, ad request 512 can contain data in data category one, data on intermediate results of the determination process described in 104 and performed in 504 but no data in data category two. For example, in embodiments using Naïve Bayes classification method in 504, data on posterior likelihoods of each predetermined possible mode, or data on prior likelihoods and conditional probabilities of the collected information items in each predetermined possible mode, can be included in ad request 512. In these embodiments, the classification method used in 504 on device 500 can be known on ad server 530 and intermediate results obtained in 504 included in ad request 512 can be transmitted to ad server 530. Ad server 530 can process them to determine a likely mode. This shifting of part or all 504 and 506 from device 500 to ad server 530 can be useful in exemplary embodiments where the communication network between device 500 and ad server 530 has high throughput and device 500 has limited computing power.

In some exemplary embodiments, data in the first data category in ad request 512 can include data on some or all of the collected information items collected in step 502 that could be useful in ad server 530. Those data can be represented in various data structure or formats, using various symbols, including words in natural language, alphanumeric characters, numerical or symbolic code, or a combination thereof. For example, in both embodiment A and B, one exemplary JSON representation of some of the exemplary collected information items at the exemplary time can be {“device_location”: {“type”: “Point”, “coordinates”: [−79.046, 35.917]}, “mode_time”: {“unix_time”: “1410274800”}, “timezone”: “−4”}.

Mode time and time zone, if collected as an information item in 502, can be useful for selecting relevant ads on ad server 530. Device location, if collected as an information item in 502, can be useful for selecting relevant ads on ad server 530. Device location can also be represented by a geographic object. In some exemplary embodiments, a geographic object can be represented or approximated using GeoJSON specification for geometry primitives or multipart geometries (http://geojson.org/geojson-spec.html). In some exemplary embodiments, to protect user's location privacy, device location included in ad request 512 can be intentionally made coarser or less precise than that collected on device 500, such as using a polygon larger than necessary for estimated device location or using one geographical point inside a geographical area to represent the geographical area.

In embodiments within embodiment group one, data in the second data category in ad request 512 can be a list of need-words. A need-word can contain one or more words in a natural language related to or describing a need. A predetermined need-word for each predetermined possible need can be retrieved from a local or remote storage medium or otherwise made known on device 500 in 508. For example, in embodiment A, the need-word for each possible need can be known as follows in 508 (number before dash is the need-code of a predetermined need and words quoted are corresponding need-word): 1—“music”, 2—“latest electronics”, 3—“online sales”, 4—“weather”, 5—“local attractions”, 6—“drink water”, 7—“coffee tea water drinks soda”, 8—“food”, 9—“running shoes”, 10—“running shoes sale”, 11—“running outfit”, 12—“bike maintenance”, 13—“bike accessories sale”, 14—“biking trail map”, 15—“bike repair”, 16—“biking gear deals”, 17—“closest gas stations”, 18—“cheap gasoline”, 19—“traffic information”, 20—“auto maintenance service”, 21—“oil change”, 22—“auto insurance”, 23—“car accessories”, 24—“hotels vacancy”, 25—“best selling books”, 26—“popular movies”, 27—“popular video game”, 28—“popular computer game”, 29—“reject all phone calls”, 30—“take calls from (123)456-7890”, 31—“office supplies”, 32—“vacation”, 33—“savings”, 34—“investment”, 35—“sports event”, 36—“well-reviewed restaurant”, 37—“inexpensive cheap dining”, 38—“dance events”, 39—“sports shoes”, 40—“sports clothing”, 41—“energy drink”, 42—“workout guides”, 43—“workout supplements”, 44—“grocery store coupons”, 45—“grocery sales deals”, 46—“fresh produce”, 47—“new food items”, 48—“clothes fashion”, 49—“shopping mall sales”, 50—“clothes on sale”, 51—“electronics store”, 52—“birthday gift”, 53—“holiday gift”, 54—“clothes fashion sale”, 55—“museums”, 56—“popular TV shows”, 57—“popular movie trailer”.

In embodiments within group one, device 500 can select one or more need-words corresponding to one or more needs in the likely need, organize them as a list and put the list into ad request 512 in a predetermined format, as data in the second data category. Those need-words in the list can be ordered or not ordered. Various random or deterministic selection methods can be used to select need-words. In some exemplary embodiments, device 500 can select the need-words of the first or last two needs in the likely need. For example, in embodiment A, an exemplary like need can be needs 6, 12, 13, 14, 15, 16, 39, 40, 41, 42, 43. Device 500 can select “drink water” for need 6 and “bike maintenance” for need 12. Alternatively, device 500 can select need-words corresponding to some randomly selected needs in the likely need, if more than one needs are included in the likely need. For example, in embodiment A, device 500 may randomly select need 15 and 41 and need-words “bike repair” and “energy drink”. Device 500 can organize all selected need-words into a need-word list and put the list into ad request 512 in a predetermined format. For example, in embodiment A, the need-word list in ad request 512 can be represented in JSON format. One example can be {“need-words”: “bike repair energy drink”}. Another one can be {“need-words”: “drink water bike maintenance”}.

In embodiments within group two, data in the second data category in ad request 512 can be a list of need-codes.

The need-code list may or may not contain all need-codes of all the needs in the likely need. Device 500 can select one or more needs in the likely need, organize their need-codes into a list and put the list in ad request 512. Various random or deterministic selection methods can be used to select needs in the likely need. In some exemplary embodiments, device 500 can select only the need-code of the first or last two needs in the likely need. For example, in embodiment B, an exemplary like need can be needs 6, 12, 13, 14, 15, 16, 39, 40, 41, 42, 43. Device 500 can select need 6, 12. Alternatively, device 500 can select one or more needs in the likely need randomly, with each need having a predetermined probability of being selected. For example, in embodiment B, device 500 can select needs 12 and 39 from the random process described above. In some exemplary embodiments, device 500 can select all needs in the likely mode. Device 500 can organize need-codes of selected needs into a list. For example, in embodiment B, the need-code list can be “6, 12.” It can also be “6, 12, 13, 14, 15, 16, 39, 40, 41, 42, 43.” Device 500 can then put the need-code list into ad request 512 in a predetermined format. For example, in embodiment B, the need-code list can be put into ad request 512 in JSON format. One example can be {“need-codes”: “12, 39”}.

Data in ad request 512 can be organized or formatted using various data structures or data formats. One exemplary JSON representation of ad request 512 in embodiment A can be {“need-word”: “bike maintenance drinks water”, “device_location”: {“type”: “Point”, “coordinates”: [−79.046, 35.917]}, “mode_time”: {“unix_time”: “1410274800”}, “timezone”: “−4”, “screen_size”: {“cm”: “10”}}. One exemplary JSON representation of ad request 512 in embodiment B can be {“need-code”: “6, 12, 13, 14, 15, 16, 39, 40, 41, 42, 43”, “device_location”: {“type”: “Point”, “coordinates”: [−79.046, 35.917]}, “mode_time”: {“unix_time”: “1410274800”}, “timezone”: “−4”, “advertisement_allowed”: {“sexual_explicit”: “false”}}. It will be understood by persons of ordinary skills in the art that other data structure or data formats can also be used to organize or format data in ad request 512, such as XML 1.0, with predefined element names and attributes.

Ad request 512 can be transmitted over a communications network to server 530. Ad request 512 can be encrypted, authenticated or otherwise processed, using an appropriate protocol or framework that is known or will be known in the art, during the transmission process to ensure its anonymity, authenticity, completeness or other properties. In some exemplary embodiments, to defend against potential eavesdroppers, ad request 512 can be first encrypted using the public key in a predetermined public-private key pair. A cipher version of ad request 512 can be transmitted over a network to server 530. Server 530 can use the private key in the public-private key pair to decrypt the cipher version and obtain the plaintext version of ad request 512. In some exemplary embodiments, the following protocol can be implemented to ensure the authenticity and completeness of ad request 512 received by server 530. Device 500 can apply a predetermined hash function to ad request 512 to obtain a digital signature of ad request 512. An exemplary predetermined hash function can be one from the Secure Hash Algorithm (SHA) hash function family as defined by U.S. Federal Information Processing Standards (e. g. FIPS PUB 180-4). Device 500 can encrypt the digital signature using the private key in a predetermined public-private key pair to obtain a cipher signature. Device 500 can transmit both plaintext ad request 512 and the cipher signature to server 530. Upon receiving both ad request 512 and an associated cipher signature, server 530 can use the public key in the public-private key pair to decrypt cipher signature to obtain a plaintext signature. Server 530 can apply the same predetermined hash function to the plaintext ad request 512 received and compare the output against the plaintext signature. If they are the same, then the authenticity and completeness of ad request 512 can be verified. If they are not the same, the authenticity and completeness of ad request 512 can be rejected. In some exemplary embodiments, to provide anonymity, ad request 512 can be transmitted over a Tor network or one employing onion routing on its way to server 530.

It will be understood by persons of ordinary skills in the art that many other protocols, methods and systems known in the art can be used or implemented to provide or ensure anonymity, authenticity, completeness, or other properties of ad request 512 received by server 530.

Server 530 can refer to a single computing device with a storage medium, or a group of two or more communicatively connected computing or storage devices. Server 530 can be administrated or controlled by an advertising company, its agent, contractor, or anyone authorized. An advertising company can be defined as an individual or a corporate entity which can place an ad from one or more advertisers to advertising platform 560, or cause it to be so placed. Advertising platform 560 can be device 500 or an apparatus around device 500 capable of exposing an ad to a user.

Server 530 can select 532 a number of candidate ads from ad store 540 on server 530.

Ad store 540 can store ads on a persistent storage medium, non-persistent storage medium, or a combination thereof. Ads stored in ad store 540 can be read and modified by server 530. Ad store 540 can be local to server 530, or can be entirely or partially remotely implemented on one or more other computing or storage devices.

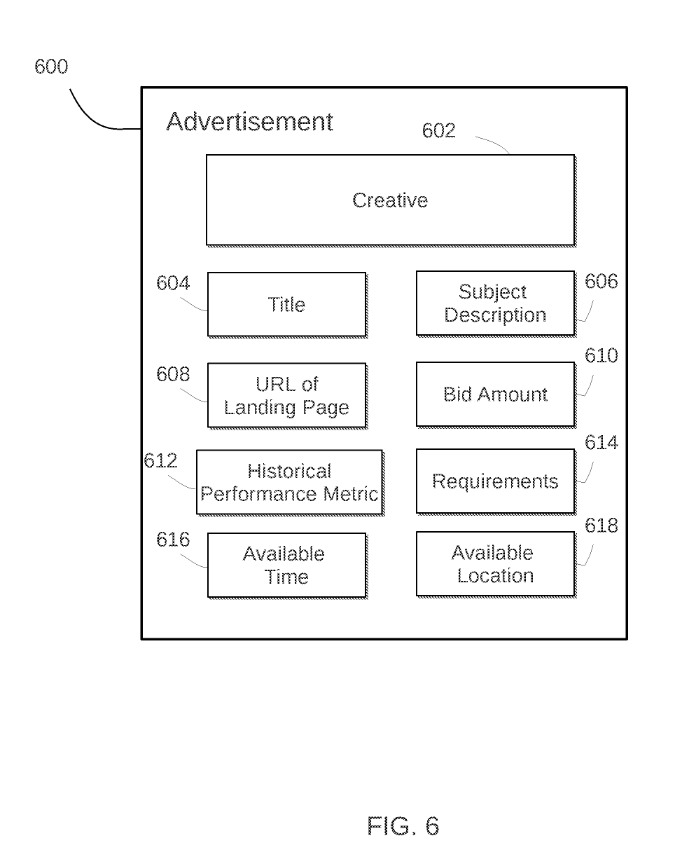

In different embodiments, ads in ad store 540 can contain different components. Further details of exemplary components in an ad in ad store 540 will be discussed below in reference to FIG. 6.

A large number of ads can be stored in ad store 540. Since a user's needs can change quickly, time is often of the essence. In some exemplary embodiments, ad server 530 should be able to serve ads to advertising platform 560 in response to ad request 512 in real time or near real time, usually no later than a few minutes. In some exemplary embodiments, server 530 can select a predetermined number of candidate ads from some or all ads in ad store 540. Server 530 can select those candidate ads partially based on data in the third data category in ad request 512. For example, server 530 can select the first 1,000 ads whose categorization matches categories of ads allowed in ad request 512, such as {“sexual_explicit”: “false”}. In some exemplary embodiments, server 530 can determine the number of candidate ads to be selected in 532 based on its own computing power, or system workload, throughput of the communication network connecting server 530 and platform 560, or the like.

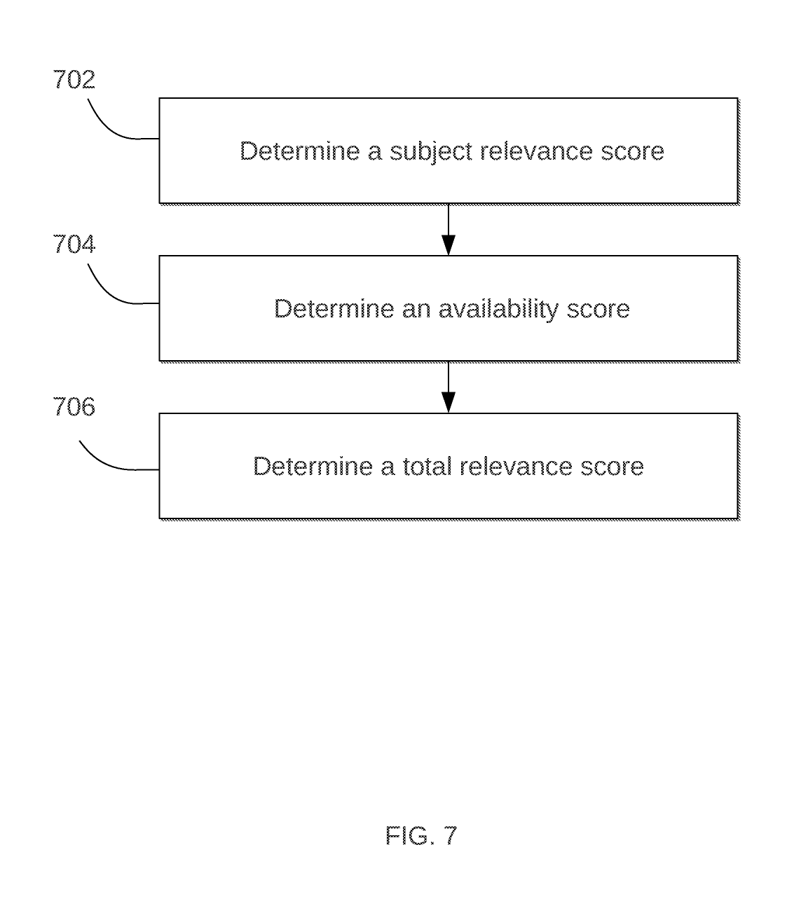

For each selected candidate ad, server 530 can determine 534 a total relevance value between the ad and data within the first and second data categories in ad request 512. An exemplary process of determining a total relevance value between an ad and an ad request will be described in details in reference to FIG. 7.

Server 530 can select 536 one or more final ads from the candidate ads based on their total relevance scores. In some exemplary embodiments, server 530 can select the final ads with the highest total relevance scores. The exact number of final ads can be fixed, such as 2, or can be based on data in the third data category in ad request 512. For example, it can be based on the screen size of device 500, with smaller screen sizes having smaller number of final ads. They can be sorted based on the total relevance scores as well. For example, the first final ad selected has the highest total relevance score.

In some exemplary embodiments where there is at least one candidate ad with a non-zero total relevance value, server 530 can form a discrete probabilities distribution over all such candidate ads, with the probability of each ad being selected proportional to its non-zero total relevance value. Server 530 can then randomly select, with or without replacement from that distribution, one or more final ads.

Server 530 can serve 538 the final ads to platform 560. Those final ads are included in served ads 550. Not all components of final ads are necessarily included in served ads 550. In some exemplary embodiments, only creatives are included in served ads 550.

Upon receiving served ads 512, platform 560 can process and expose 562 them to the user. In some exemplary embodiments, a creative of an ad in served ads 550 can be a banner and platform 560 can be device 500. Device 500 can display the banner on its screen. In some exemplary embodiments, the creative to be exposed is a short text message and platform 560 is a computing device with a speaker. The device can display the text message on its screen, or convert it to computer synthesized speech and play the result on its speaker.

Platform 560 can expose each ad in served ads 550 for a given duration, e. g. 5 seconds. When more than one ad is contained in served ads 550, and only one ad can be shown on the platform at one time, the ads can be exposed sequentially in the same order as they are received on the platform.

After a given amount of time has passed since an ad starts to be exposed to the user, advertising platform 560 can determine the performance of the ad, such as if a desired action, such as clicking, touching, purchasing, or walking to the store, has been taken by the user. Device 500 can record 564 performances of some or all ads in served ads 550 and transmit performance feedbacks 570 to server 530. Feedbacks 570 contains performances of some or all ads in served ads 550 in a predetermined format, which includes identification information of the ad being shown and specific action taken, and so on. Upon receiving it, server 530 can update the performance metric in the corresponding ad in ad store 540 accordingly.

Methods and systems for an advertiser to open, manage, administrate an account with the advertising company, submit ads to the advertising company to be stored in ad store 540, set certain filtering criteria on an ad to restrict its availability based on those criteria when applicable, such as geographical area, time, certain demographic group of users, and so on, and set up a bid amount for an ad have been well known in the art. They are omitted in this disclosure as not to obscure the discussion.

### Advertisement in Ad Store

FIG. 6 is a diagram illustrating exemplary components in an ad stored in an ad store.

Ad 600 in ad store 540 can include creative 602. Creative 602 is a component of ad 600 that will be displayed, played, or otherwise exposed to the audience of the ad. It is the component of ad 600 that the user of device 500 can sense. Creative 602 can be a graphic, text, animation, audio segment, video segment or a combination thereof. Creative 602 promotes a subject of ad 600, which is a product, service, information or view that ad 600 is created to promote.

Ad 600 can also include one or more of the following: title 604, subject description 606, URL 608 of a landing page, bid amount 610, historical performance metric 612 such as click-through rate (CTR) or conversion rate, or requirements 614. Tile 604 can contain one or more words in a natural language summarizing the ad. For example, an exemplary title of an ad from XYZ bicycle repair shop can be “XYZ bicycle repair shop”. URL 608 of landing page can the URL of first content page that will be shown to the user when he starts to touch, click or interact with the ad. Bid amount 610 concerns things of value, such as money, which the advertiser agrees to pay the advertising company for each impression of the ad, or each specific benefit the advertiser receives, such as a click on the ad, a transaction such as a purchase or the like. Impression can be either a served or viewable impression. Requirements 614 contains required user preferences, or required hardware capabilities or both in order for the ad to be exposed to a user of device 500. One JSON representation of requirements 614 in an ad by a pizza shop named BestPizza can be {“requirements”: [{“sexual_explicit”: “false”}, {“audio_enabled”: “false”}]}. Requirements 614 in an ad can be used by server 530 to filter ads based on data on static information items in the third data category in ad request 512.

Historical performance metric 612 can be any numeric or symbolic metric representing past or default performance of ad 600. In this disclosure, CTR or conversion rate can be defined to be the ratio between the number of clicks or other desired user actions (i. e. conversions) over the total number of impressions, respectively. Both can be stored as a pair of integers (s,n) in various data format or data structures. s can be the number of times the user clicks or takes the desired action and n can be the total number of impressions. When an impression of the ad has been made (e. g. server 530 transmits the ad to advertising platform 560 or the ad is exposed to the user through platform 560) and performance feedbacks 570 including whether or not a user clicks, or takes a desired action is subsequently transmitted back to server 530, s and n of the ad in ad store 540 can be incremented accordingly. CTR or conversion rate can be computed by dividing s by n. Initial values of s and n can be such that s divided by n would give a default CTR or conversion rate. For example, if default CTR is set to be 0.01, initial values of s and n can be set to 1 and 100 respectively.

Ad 600 can also include available time 616, available locations 618 or both. Available time 616 and available location 618 describe the time and locations that a subject of ad 600 is available to the user of device 500, respectively. Both of them can be represented in a variety of ways and in a variety of formats. Available time 616 can be represented by a collection of time intervals during which the subject of ad 600 will be available in the next 5, 10, or 100 years, with the start and end of each interval expressed in UNIX time (i. e. UNIX time intervals). Available time 616 can also be represented by a collection of calendar day schedules, with each such schedule describing time intervals the subject of ad 600 is available during that day. Available location 618 can be represented by a geographic object that is expressed in GeoJSON format. Available location 618 can also be represented in a variety of other formats. One such format can be using numerical or symbolic code that designates a predetermined geographic region, such as ZIP code used by United State Postal Office, or two letter abbreviation of U.S. states.

For example, a pizza shop named BestPizza can have the following business hours: open Monday through Friday 5 a.m. to 10 p.m., Saturday 5 a.m. to 11 a.m. and 1 p.m. To 10 p.m., closed Sundays, Thanksgiving and Christmas, and open Independence day from 5 a.m. to 6 p.m. Its store is located at the following coordinates, [−79.03, 35.93] with first number in the pair being longitude and second latitude. An ad promoting pizza sold by BestPizza pizza shop in ad store 540 can have available time and available locations in JSON format as the following: {“available_time”: {“calendar”: “Gregorian”, “time_zone”: “United States Eastern Daylight Time”, “weekly_schedule”: {“sunday”: {“start”: “00:00:00”, “end”: “00:00:00”}, “monday”: {“start”: “05:00:00”, “end”: “22:00:00”}, “tuesday”: {“start”: “05:00:00”, “end”: “22:00:00”}, “wednesday”: {“start”: “05:00:00”, “end”: “22:00:00”}, “thursday”: {“start”: “05:00:00”, “end”: “22:00:00”}, “friday”: {“start”: “05:00:00”, “end”: “22:00:00”}, “saturday”: [{“start”: “05:00:00”, “end”: “11:00:00”}, {“start”: “13:00:00”, “end”: “22:00:00”}]}, “holiday_schedule”: {“Thanksgiving”: {“start”: “00:00:00”, “end”: “00:00:00”}, “Christmas”: {“start”: “00:00:00”, “end”: “00:00:00”}, “Independence”: {“start”: “05:00:00”, “end”: “18:00:00”}}}, “available_location”: {“type”: “Point”, “coordinates”: [−79.03, 35.93]}}. As another example, an online store (www.examplestore.com) can be open 24/7, except system maintenance days, and its purchasable items can be legally purchased in and shipped to anywhere in four states of U.S.: Maine, Massachusetts, New York, and New Jersey. Its ad in ad store 540 can have available time and available location expressed in JSON as the following {“available_time”: [{“start”: “1388534500”, “end”: “1425168000”}, {“start”: “1425254500”, “end”: “1483228800”}], “available_location”: [{“state”: “me”}, {“state”: “ma”}, {“state”: “ny”}, {“state”: “nj”}]}.

Formats or data structures that can be used by an ad to express its available time and available locations can be predetermined. When an ad does not have an available time or has one in an invalid format, server 530 can assume all subjects of the ad to be unavailable all the time, or available all the time. When an ad does not have available location or has one in a invalid format, server 530 can assume them to be unavailable everywhere or available everywhere.

In embodiments within group one, ad 600 can contain subject description 606 and subject description 606 contains a keyword, which is one or more words in natural languages.

For example, in embodiment A, each ad in ad store 540 can contain a creative, title, subject description, available time, available location, and a bid mount. It may also contain one or more of the following: URL of a landing page and requirements. In embodiment A, the subject description in each ad contains a keyword. The bid amount in each ad represents the amount of money the advertiser agrees to pay the advertising company for every click on the ad generated on device 500. Four exemplary ads, ad A, B, C, and D, in ad store 540 in embodiment A can be described follows. Ad A has title “XYZ bicycle repair shop”, subject description “bike bicycle repair maintenance parts helmet”, available time {“available_time”: {“calendar”: “Gregorian”, “time_zone”: “United States Eastern Daylight Time”, “weekly_schedule”: {“sunday”: {“start”: “00:00:00”, “end”: “00:00:00”}, “monday”: {“start”: “09:00:00”, “end”: “17:00:00”}, “tuesday”: {“start”: “09:00:00”, “end”: “18:00:00”}, “wednesday”: {“start”: “09:00:00”, “end”: “17:00:00”}, “thursday”: {“start”: “09:00:00”, “end”: “17:00:00”}, “friday”: {“start”: “09:00:00”, “end”: “17:00:00”}, “saturday”: {“start”: “12:00:00”, “end”: “17:00:00”}}, “holiday_schedule”: {“thanksgiving”: {“start”: “00:00:00”, “end”: “00:00:00”}, “christmas”: {“start”: “00:00:00”, “end”: “00:00:00”}}}, available location {“available_location”: {“type”: “Point”, “coordinates”: [−79.00, 35.91]}}, requirements {“requirements”: [{“sexual_explicit”: “false”}, {“audio_enabled”: “false”}]}, bid amount 0.02 USD and a URL of one of the web pages on its website. Ad B has title “ABC auto insurance”, subject description “car cheap auto insurance”, available time {“available_time”: [{“start”: “1388534500”, “end”: “1425168000”}, {“start”: “1425254500”, “end”: “1483228800”}]}, available location {“available_location”: [{“state”: “nc”}, {“state”: “va”}]}, requirements {“requirements”: [{“sexual_explicit”: “false”}, {“audio_enabled”: “false”}]}, bid amount 0.03 USD and a URL of the main page of ABC company's website. Ad C has title “CRB coffee shop”, subject description “coffee water snack”, available time {“available_time”: {“calendar”: “Gregorian”, “time_zone”: “United States Eastern Daylight Time”, “weekly_schedule”: {“sunday”: {“start”: “07:00:00”, “end”: “20:00:00”}, “monday”: {“start”: “07:00:00”, “end”: “20:00:00”}, “tuesday”: {“start”: “07:00:00”, “end”: “20:00:00”}, “wednesday”: {“start”: “07:00:00”, “end”: “20:00:00”}, “thursday”: {“start”: “07:00:00”, “end”: “20:00:00”}, “friday”: {“start”: “07:00:00”, “end”: “20:00:00”}, “saturday”: {“start”: “07:00:00”, “end”: “20:00:00”}}}}, available location {“available_location”: {“type”: “Polygon”, “coordinates”: [[[−79.03, 35.92], [−79.03, 35.921], [−79.031, 35.921], [−79.031, 35.92], [−79.03, 35.92]]]}}, bid amount 0.01 USD and a URL of the main page on CRB coffee shop's website. Ad D has title “BestPizza fast delicious pizza”, subject description “food pizza snack soda water”, same available time and available location as those in the ad by BestPizza pizza shop as described in paragraph 0130, bid amount 0.05 USD, and a URL of a web page listing its street address, phone numbers, and other information. Creatives of the four exemplary ads above are not described here as their particular contents or formats are not relevant to the discussion here.

In embodiments within group two, ad 600 contains subject description 606 and subject description 606 contains an R-table. R-table is a table where the first column of each row is a need code and the second column of the same row is a numeric relevance value measuring how relevant a subject of ad 600 is to the need represented by the need code in the first column. A default numeric value such as 0 can mean no relevance. Only rows with non-default relevance values exist in the R-table. A constraint can be put on the R-table, such as the sum of all numerical relevance values in all rows should be less than or equal to a predetermined value, e. g. 5.0 or 10.0. Negative relevance values are allowed to show negative relevance (i. e. the subject of ad 600 is contrary to the need).

The R-table in ad 600 can be determined when ad 600 is created or changed. In some exemplary embodiments, the determination of R-table can be performed by one or more experts manually, such as the ad's creator, an advertiser, or its agent. Experts can understand all possible needs in an embodiment and the ad. For each need, they can then subjectively determine an initial numerical relevance value. In some exemplary embodiments, computer implemented methods can be used to determine the initial numeric relevance value in an R-table in ad 600. For example, when the creative, title, description, landing page or other parts of ad 600 contain words in a natural language, any method which can determine a numerical relevance value between a phrase, sentence, or text expressing or representing a need, and a collection of words which include all the words in the ad and optionally its landing page can be used to determine an initial relevance value in each row in an R-table of the ad. One such method is described in detail in reference to FIG. 7. Another such method was described by Krishna, Kumar, and Reddy in their article, A Hybrid Method For Query Based Automatic Summarization System, International Journal of Computer Applications, Volume 68−No. 6, April 2013. It will be understood by persons of ordinary skills in the art that any method known in the art now or that will be known in the art in the future that can determine a numerical relevance value between a phrase, sentence or group of words and another collection of words can also be used to determine the R-table of ad 600. In some exemplary embodiments, it can be performed using a combination of human and computing devices. For example, computers can determine a rough score and humans can refine it. If there is a constraint such as the sum can not exceed a certain threshold, those initial numerical values can be scaled together to satisfy such constraints.

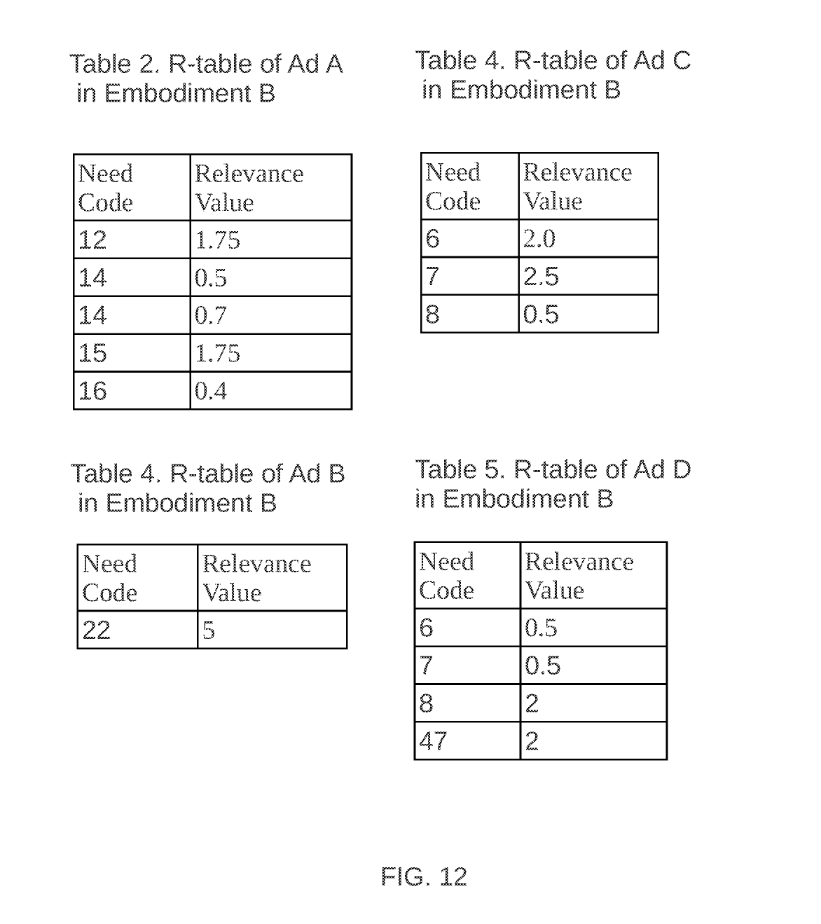

In exemplary embodiment B, each ad in ad store 540 can contain a title, landing page, available time, available locations, bid mount, R-table, as well as a historical CTR, represented by a pair of integer values in a specific data structure or format. Four exemplary ads in ad store 540 in embodiment B can be the same as the four exemplary ads in embodiment A described before, except for the following differences. Each of those ads in embodiment B does not have a keyword and its historical CTR is represented by {“ctr”: {“impressions”: “100”, “clicks”: “2”}}. Their R-tables are shown in FIG. 12.

### Total Relevance Value

FIG. 7 is a flowchart illustrating an exemplary process of determining a total relevance value between an ad and an ad request.

Server 530 can determine 702 a subject relevance score using a subject of the ad and the ad request.

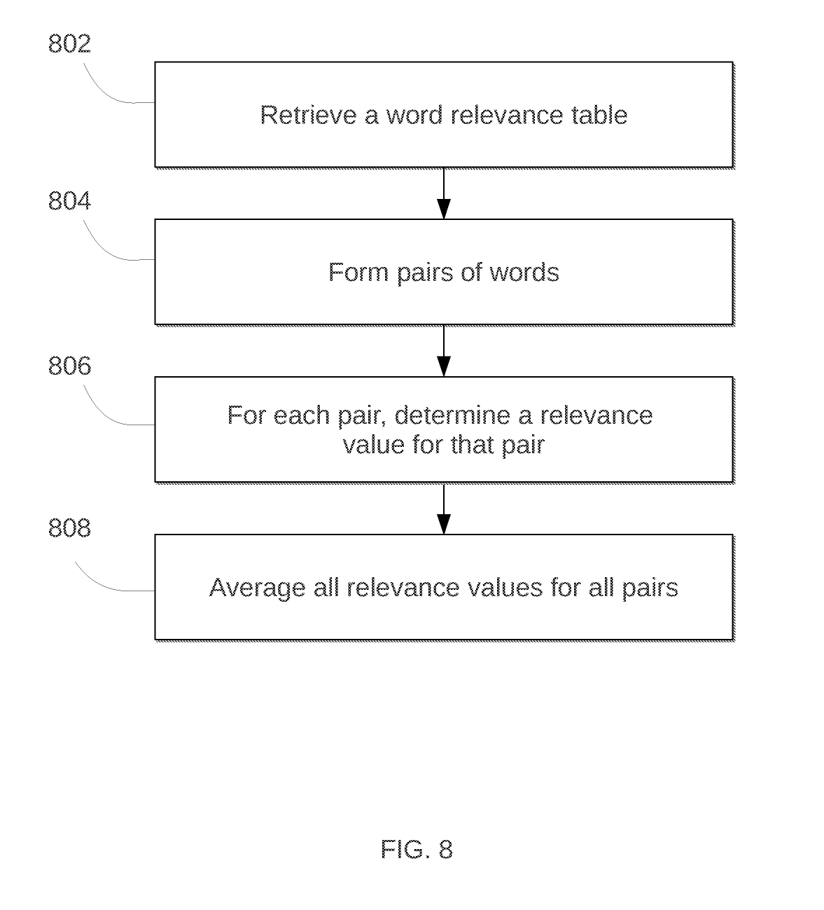

In accordance with discussions before, in embodiments within group one, an ad can contain a subject description and the subject description contains a keyword. In those embodiments, an ad request can contain a need-word list. An exemplary subject relevance score determination process using the keyword in the ad and the need-word list in the ad request will be described in detail below in reference to FIG. 8.

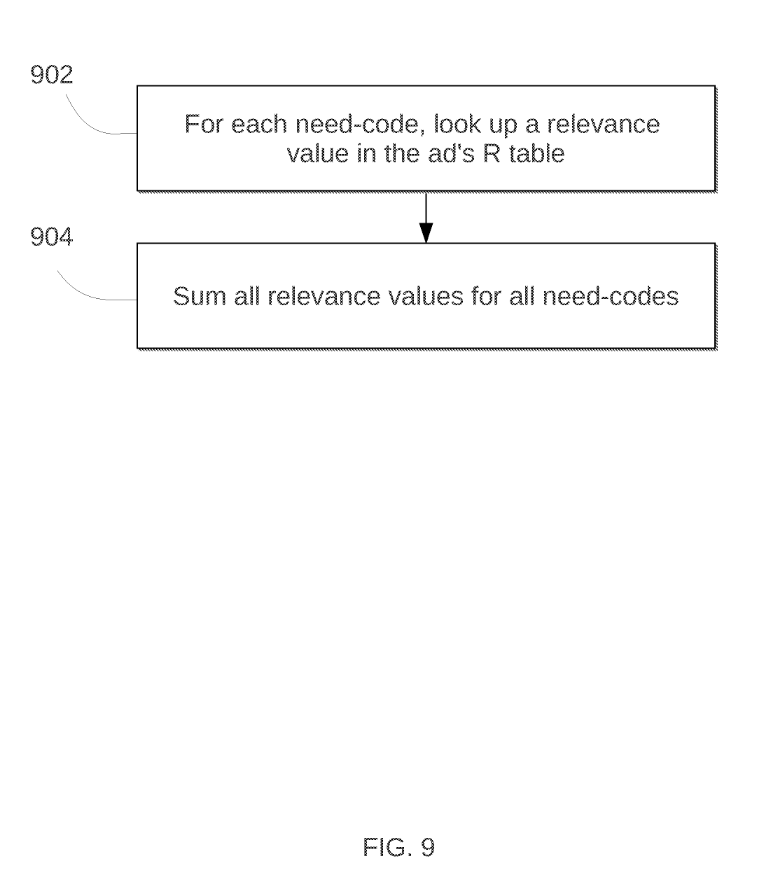

In accordance with discussions before, in embodiments within group two, an ad can contain a subject description and the subject description contains an R-table. In those embodiments, an ad request can contain a need-code list. An exemplary subject relevance score determination process using the R-table in the ad and the need-code list in the ad request will be described in detail below in reference to FIG. 9.

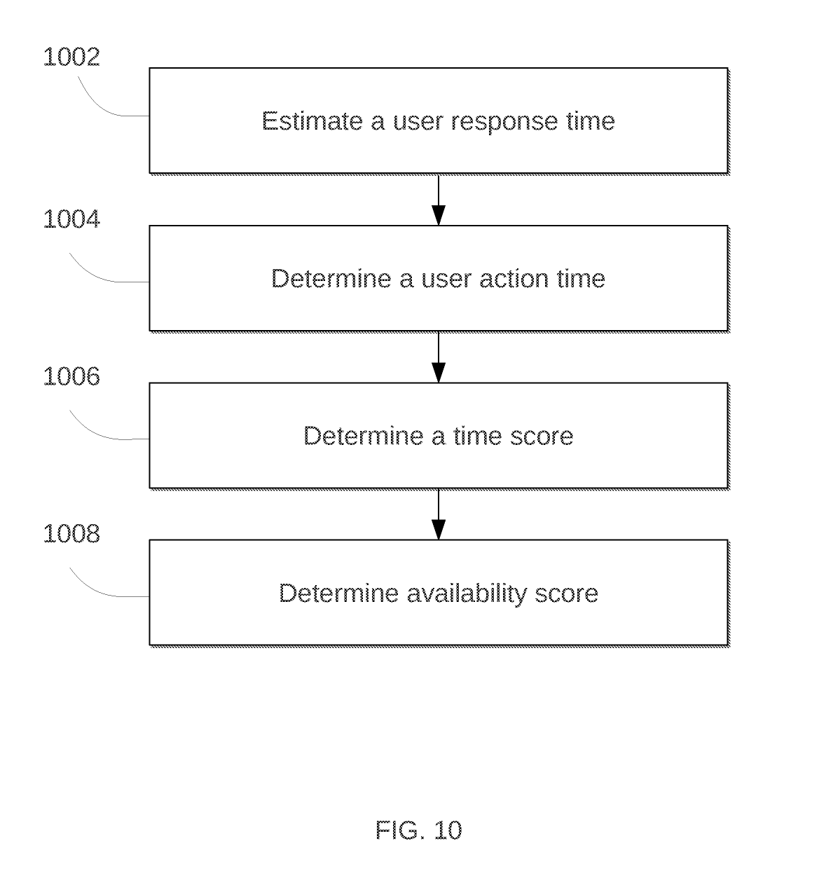

Server 530 can determine 704 an availability score of the ad using data on collected information items in the first data category in the ad request. Further details of an exemplary process of determining availability score will be described below in reference to FIG. 10. When the ad have no or an invalid available time, or no or an invalid available location, step 704 can be omitted or made trivial, such as setting the availability score of the ad to be constant 1 or 0.

Server 530 can determine 706 a total relevance score of the ad using the subject relevance score as determined in 702, the availability score as determined in 704. For example, the total relevance score can be determined to be the product of the subject relevance score and the availability score.

In some exemplary embodiments where the ad has a bid amount, the total relevance score can be determined to be the product of the subject relevance score, the availability score, and the bid amount. In some exemplary embodiments where the ad has a bid amount and a historical performance metric, such as a CTR or a conversion rate, the total relevance score can be determined to be the product of the subject relevance score, the availability score, the bid amount and the historical performance metric.

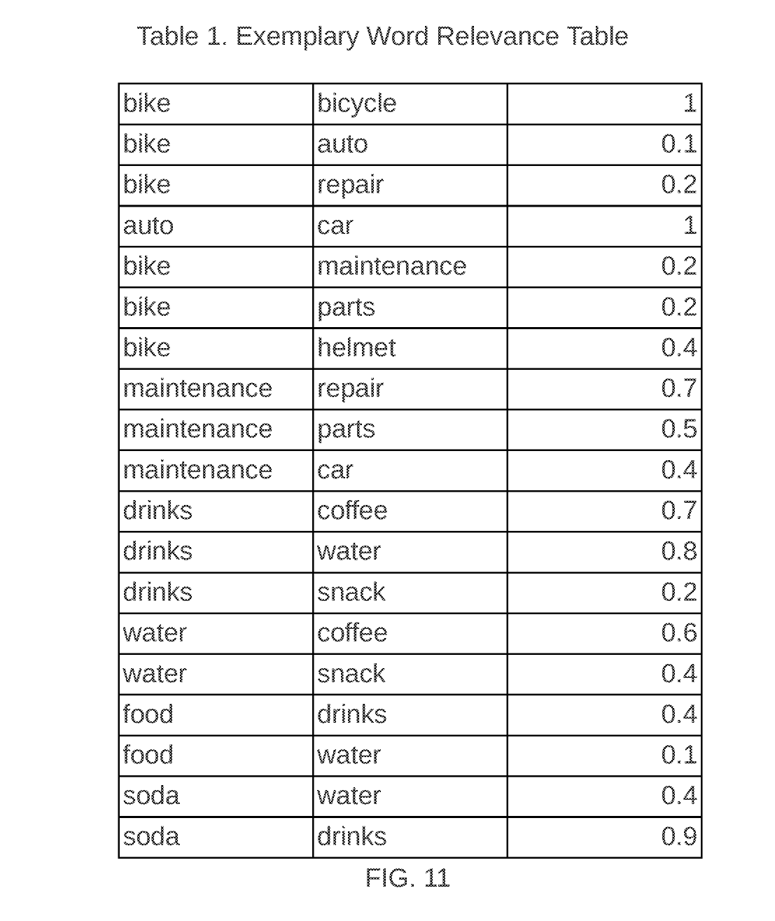

For example, in embodiment A, ad request 512 can contain a need-word list “bike maintenance drinks water”. Server 530 can select the four exemplary ads in ad store 540 as candidate ads. Server 530 can determine the total relevance value for each of them as follows. Following the process described in FIG. 8 and using Table 1 in FIG. 11, server 530 can determine the subject relevance score for ad A to be 0.23, ad B 0.06, ad C 0.30, and ad D 0.18. Following the process described in FIG. 10, assuming response time constant to be 300, server 530 can determine the availability score of ad A to be 0.035, ad B 0.200, ad C 0.079, and ad D 0.061. Server 530 can determine a total relevance score between an ad and ad request 512 to be the product of an ad's subject relevance score, its availability score, its bid amount and a constant such as 1000. For example, the total relevance score between ad A and ad request 512 can be determined to be 0.16, ad B 0.375, ad C 0.707, and ad D 0.535.

As another example, in embodiment B, ad request 512 can contain a need-code list “12, 39”. Server 530 can select the four exemplary ads in ad store 540 as candidate ads. Server 530 can determine the total relevance value for each of them as follows. Following the process described in FIG. 9 and using the exemplary R-tables of the exemplary ads in FIG. 12, server 530 can determine the subject relevance score for ad A to be 1.75, ad B 0, ad C 0 and ad D 0. Following the process described in FIG. 10, assuming response time constant to be 300, server 530 can determine the availability score for ad A to be 0.035, ad B 0.200, ad C 0.079, and ad D 0.061. Ad A, B, C, D can have CTR, 0.12, 0.23, 0.05 respectively. Server 530 can determine a total relevance score between an ad and ad request 512 to be the product of the ad's subject relevance score, its availability score, its bid amount, is CTR and a constant 1000. The total relevance score between ad A and ad request 512 can be determined to be 0.1, ad B 0, ad C 0, and ad D 0.

### Subject Relevance Score

FIG. 8 is a flowchart illustrating an exemplary process of determining a subject relevance score using a keyword in an ad and a need-word list in an ad request.

In some exemplary embodiments, words in the keyword of the ad do not have to be unique. Advertisers can repeat important words to increase its influence on subject relevance value.

Server 530 can retrieve 802 a word relevance table. The word relevance table can be stored on a storage medium on server 530, or remotely on another device. The first column of the table can be a word in a natural language and the second column of the table can be the same or a different word in the same or a different natural language. The third column can be a numerical word relevance value representing the relevance between words in the first column and second column, in the context of an embodiment. That numerical value can be a real number between 0 and 1, inclusive of both 0 and 1. 0 means no relevance and 1 means synonymous. The table can be manually determined by one or more human beings, with or without assistance of a computer, based on their understanding of meaning of those words in the context of the embodiment. Value for the same two words can be different in different embodiments. Only rows with non-zero word relevance values are stored.

Rows with same word in the first and second column have word relevance value 1 and can be kept or omitted. An exemplary word relevance table, table 1, can be shown in FIG. 11.

Server 530 can form 804 pairs of words, with the first one in the pair being a word in the keyword of the ad and the second a word contained in the need-word list.

For each pair, server 530 can determine 806 a relevance value for that pair by looking it up in (or referencing) the word relevance table. Order of words within the pair is not important in the looking up process. When a matching row is found in the table (i. e. first column of the row matches one word in the pair and second column matches the other word), the relevance value for the pair is determined to be the value in the third column of that row. When no exact match is found, one or both words in the pair are replaced with their synonyms in the word relevance table and resulted new pairs are looked up again. Synonyms in the table mean those words that have relevance value 1 in the table. When all possible replacements have been looked up and no match is found, the relevance value is determined to be 0. Otherwise, the relevance value for the pair is determined to be the value in the third column of any matching row.

Server 530 can average 806 all relevance values for all pairs to derive the subject relevance value.

FIG. 9 is a flowchart illustrating an exemplary process of determining a subject relevance score using an R-table in an ad and a need-code list.

For each need-code in the need-code list, server 530 can look up 902 the R-table of the ad to determine a relevance value. This relevance value provides a quantitative measure of how likely a subject of the ad is to satisfy the need. If a row exists in the R-table that contains the need-code, the relevance value for the need-code is determined to be the value in the row. When the need-code does not exist in the R-table of the ad, the relevance value is determined to be a default value indicating not relevant at all, such as 0.

Server 530 can sum 904 all relevance values for all need-codes in the need-code list to get a subject relevance score for the ad.

### Availability Score

FIG. 10 is a flowchart illustrating an exemplary process of determining availability score of an ad using data on collected information items in the first data category in an ad request.

Server 530 can first estimate 1002 a user response time for the ad. A user response time can be defined to be length of time between when a user decides to respond to a subject of an ad and when the user takes a desired action following that decision, if he ever does that. User response time can be dependent on physical distance between the user when she decides to respond, and available locations in the ad. For example, if the desired action of the ad is a click on the ad by the user on advertising platform 560, the user response time can be estimated to be zero or one second. As another example, in embodiment A, the desired action for the exemplary ad C on server 530 for CRB coffee shop can be a user ordering an item sold at its physical location. It can take time for her to physically move to the physical location of CRB coffee shop to place such an order. As yet another example, the desired action for the exemplary ad B on server 530 in embodiment A can be a user purchasing an auto insurance policy. As such policy can only be purchased within the state of North Carolina or Virginia, the user may have to first physically get into one of those two states. Generally speaking, the longer the user response time, the more work the user has to do to take the desired action in respond to the ad, and the less available the subject of the ad is.

In embodiments where the ad contains available locations and data on estimated device location is included in the ad request, server 530 can calculate a distance between the estimated device location and available locations in the ad. As discussed above, both device location and available locations in the ad can be geographic objects. In some exemplary embodiments, both can be represented in GeoJSON format. In some exemplary embodiments, one or both can be represented by codes designating predetermined geographic areas. They can be converted into GeoJSON representations by looking up a predetermined table containing all codes and corresponding areas' GeoJSON representations. Such a table can be predetermined and stored on server 530 or remotely. For example, the United States Census Bureau provides a database of TIGER/Line shapefiles for U.S. states, counties, congressional districts, school districts, or Postal Office ZIP Code Tabulation Areas. The shapefile of a predetermined geographic area can be converted into GeoJSON format using many readily available softwares in the art, such as GDAL/OGR. A table for codes representing U.S. states and their GeoJSON representations can be built accordingly. A distance between two geographic objects can be the minimum distance between any point in one object and any point in the other object. Methods for calculating such distance are well known in the art and are omitted here as not to obscure the discussion. Server 530 can estimate the user response time to be the distance divided by an estimate of average speed of movement by the user during that time. In some exemplary embodiments, the estimate can be a constant for device 500 for simplicity, such as 2 m/s (meter per second). In some exemplary embodiments where user mode at mode time is known on server 530, the estimate can be related to that mode. For example, the estimate can be 1 m/s in stationary mode, walking mode, flying mode and other-type-of-moving mode, 2 m/s for running mode, 3 m/s for biking mode, 10 m/s for driving-motorized-ground-vehicle mode.

Server 530 can determine 1004 a user action time. User action time is the time instant that the user takes a desired action in response to a subject of the ad, assuming the ad is sent by server 530 immediately to the advertising platform and the user immediately decides to respond after being exposed to the ad. In some exemplary embodiments, it can be a fixed amount time, such as 5 minutes, later from current time for simplicity. In some exemplary embodiments, it can be current time added with user response time and a fixed amount time. In some exemplary embodiments, it can be current time added with user response time, an estimate of network transmission time, wait time on platform before an ad starts to display, ad display time, user decision time, and others. Current time is readily available on almost all computing devices during their operations. Action time can be represented by UNIX time, or a time with a time zone specified.

Server 530 can determine 1006 a time score. Server 530 can determine whether the action time is within available time in an ad. When it is, time score can be determined to be 1. Otherwise, it can be determined to be 0.

In some exemplary embodiments, available time is represented by a collection of calendar day schedules in JSON format. The schedules include type of calendar, time zone, a weekly schedule and a holiday schedule. In those embodiments, action time can be first converted into a calendar day based on the calendar type and time zone in the available time of the ad. That calendar day is first compared with the holiday schedule. If that calendar day is one of the holidays listed, the time of day of the action time is then compared with applicable available time intervals of that holiday. Otherwise, day of the week of the action time is determined and time of the day of action time is compared with applicable time intervals for applicable day in the weekly schedule. When action time in within any of applicable time intervals, the time score can be determined to be 1. Otherwise, it can be 0.

In some exemplary embodiments, available time is represented as a list of available time intervals in the next 1, 10, or 100 years, with the start and end of each interval expressed in UNIX time. Action time can be first converted into UNIX time, if it is not already a UNIX time, and then compared against all the intervals. When action time in within any of applicable time intervals, the time score can be determined to be 1. Otherwise, it can be 0.

Server 530 can determine 1008 availability score by performing a mathematical operation on user response time and time score, with larger user response time resulting in lower availability score and higher time score resulting in higher availability score. For example, the operation can be time score divided by the sum of user response time and a predetermined response time constant, such as 300.

### User Need Estimation System

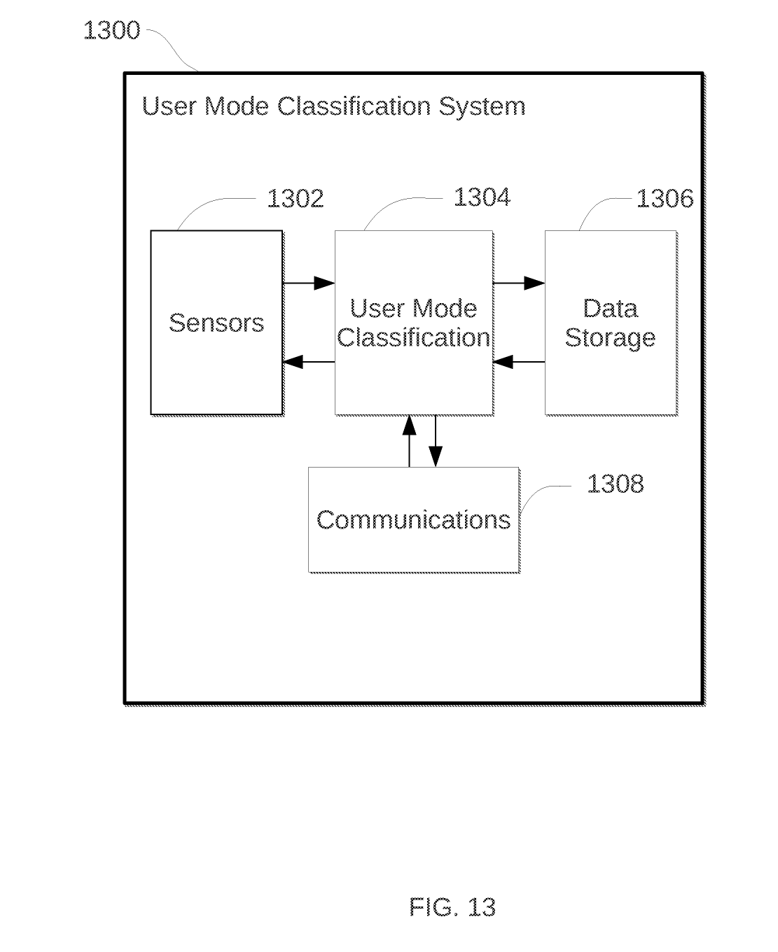

FIG. 13 is a block diagram illustrating functional components of an exemplary user need estimation system. User need estimation system 1300 can be a component of device 100 as described above in reference to FIG. 1, or can be a component of device 500 as described above in reference to FIG. 5.

System 1300 can include data storage unit 1306. Unit 1306 can be a non-transitory data storage component of system 1300 that is configured to store data required for user mode classification on system 1300, such as data on a prior likelihood of each predetermined possible user mode, data on conditional probability distribution of information item in each predetermined possible mode, data on conditional probability or conditional probability density of collected information items in each predetermined possible mode, data on decision trees used in user mode classification, or any other instructions and data for user mode classification unit 1304 to perform required operations. Unit 1306 can also store predetermined configurations of device 100 for each mode, commands and data associated with each mode, command and data related to a predetermined task, as well as other related data.

System 1300 can include sensors unit 1302. Unit 1302 is part of system 1300 which is configured to observe the information items collected in operation 102. Unit 1302 can include at least one of the following: a touch screen, microphone, digital camera, wireless transceiver, accelerometer, gyroscope, magnetometer, thermometer, acoustic-to-electric transducer or sensor, receiver of a navigation satellite system, humidity sensor, air pressure sensor, light sensor, proximity sensor, heart rate sensor, blood glucose level sensor and the like.

System 1300 can include user mode estimation unit 1304. Unit 1304 can contain one or more processors and instructions to run the processors to perform some or all of operations 102, 104, 106 as described in detail in reference to FIG. 1, in collaboration with unit 1302, unit 1306 and unit 1308.

System 1300 can include communications unit 1308. Unit 1308 can be a component of system 1300 that is configured to communicate with other different devices or apparatus over a wired or wireless communications network. Unit 1308 can contain one or more wireless transceivers.

### Advertising Based on User Need Estimation System

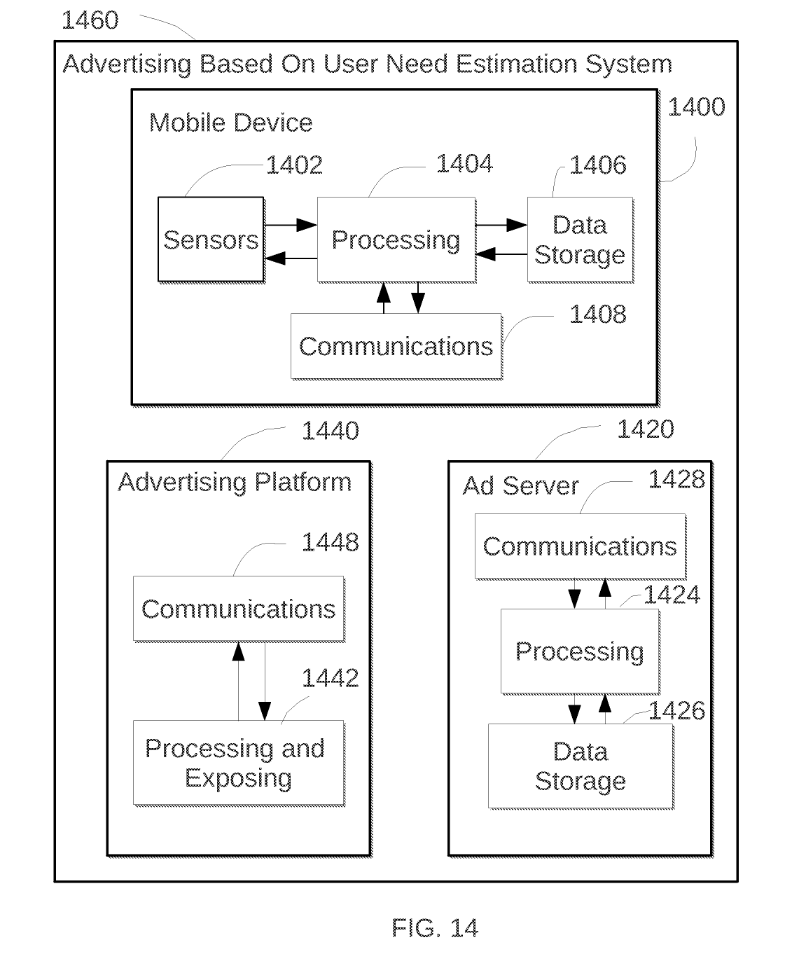

FIG. 14 is a block diagram illustrating functional components of an exemplary advertising based on user need estimation system.

Advertising based on user need estimation system 1460 contains three sub-systems, mobile device 1400, ad server 1420, and advertising platform 1440. Advertising platform 1440 can be part of device 1400, physically attached to device 1400, or can share some common components or parts with device 1400. Device 1400 can communicate with server 1420, which can communicate with platform 1440. Device 1400 may or may not be able to communicate directly with platform 1440.

Device 1400 can include data storage unit 1406. Unit 1406 can be a non-transitory data storage component of device 1400 that is configured to store data required for user mode classification on device 1400 or ad server 1440 or a combination of both, such as data on prior likelihood of each predetermined possible user mode, data on conditional probability distribution of information item in each predetermined possible mode, data on conditional probabilities or conditional probability densities of collected information items in each predetermined possible mode, data on decision trees used in user mode classification, or any other instructions and data for processing unit 1404 to perform required operations. Unit 1406 can also store other related data.

Device 1400 can include sensors unit 1402. Unit 1402 is part of device 1400 which is configured to observe the information items collected in 502. Unit 1402 can include at least one of the following: a touch screen, microphone, digital camera, wireless transceiver, accelerometer, gyroscope, magnetometer, thermometer, acoustic-to-electric transducer or sensor, receiver of a navigation satellite system, humidity sensor, air pressure sensor, light sensor, proximity sensor, heart rate sensor, blood glucose level sensor, and the like.

Device 1400 can include processing unit 1404. Unit 1404 can contain one or more processors and necessary instructions to run the processors to perform some or all of operations 502, 504, 506, 508 and 510 as described in details in reference to FIG. 5, in collaboration with unit 1402, unit 1406 and unit 1408.

Device 1400 can include communications unit 1408. Unit 1408 can be a component of system 1400 that is configured to communicate with other different devices or apparatus over a wired or wireless communications network, including server 1420. Unit 1408 can contain one or more wireless transceivers or wired network adapters.

Server 1420 can include communications unit 1428. Unit 1428 can be a component of server 1420 that is configured to communicate with other different devices or apparatus over a wired or wireless communications network, including device 1400 and platform 1440. Unit 1408 can contain one or more wireless transceivers or wired network adapter.

Server 1420 can include processing unit 1424. Unit 1424 can contain one or more processors which can be configured to perform some or all of operations 532, 534, 536, 538, 572 as described in details in reference to FIG. 5. In some embodiments, the processors in unit 1424 can also be configured to perform part or all of user mode estimation 504 as described in details in reference to FIG. 5.

Server 1420 can include data storage unit 1426. Unit 1426 can store ads and instructions for unit 1424.

Platform 1440 can include communications unit 1448. Unit 1448 can be a component of server 1440 that is configured to communicate with other different devices or apparatus over a wired or wireless communications network, including server 1420. Unit 1448 can contain one or more wireless transceivers or wired network adapter.

Platform 1442 can include processing and exposing unit 1442. Unit 1442 can perform some or all of operation 562 and 564 as described in details in reference to FIG. 5.

What is claimed is:

1. A method implemented on a mobile device, comprising:
collecting a plurality of information items at or around a given time;
determining, using the collected information items, a likely mode of the activities of a person who at said given time is in close physical proximity to said device, said likely mode being one or more modes among three or more predetermined possible modes; and
performing, in response to said likely mode or intermediate results of the determination, a predetermined task.

2. The method of claim 1, wherein said device is a smart phone, a feature phone, a laptop, a wearable computing device, a tablet, a portable digital sensor, or other portable computing device.

3. The method of claim 1, wherein said device is a group of two or more communicatively connected computing devices, wherein at least one of said computing devices is a smart phone, a feature phone, a laptop, a wearable computing device, a tablet, a portable digital sensor, or other portable computing device.

4. The method of claim 1, wherein said plurality of information items comprises at least two items selected from the group consisting of:
said given time;
length of a time interval that begins or ends at said given time;
information about a phone call made or received recently on said device;
whether or not said person is interacting with said device;
linear or angular acceleration measurement taken on said device or related statistics;
angular velocity measurement taken on said device or related statistics;
orientation of said device;
geographic location of said device;
speed of said device;
sound level measured on said device or related statistics;
identification information of detected wireless signal emitters or strengths of their detected signals;
magnitude measurement of an external electric, magnetic, or electromagnetic field taken on said device or related statistics;
ambient air temperature measured on said device or related statistics;
ambient air pressure measured on said device or related statistics;
ambient air humidity level measured on said device or related statistics;
pressure exerted on a touch screen of said device or related statistics;
luminance measured on said device or related statistics;
intensity of an ionizing radiation measured on said device or related statistics;
ambient concentration of a chemical element or compound measured on said device or related statistics; and
a physiological measurement of said person taken on said device or related statistics.

5. The method of claim 1, wherein said predetermined task comprises at least one selected from the group consisting of:
shutdown of a computer program or a feature of a computer program running on said device;
starting a computer program or a feature of a computer program on said device;
switching a computer program running on said device from one operation mode, to another different operation mode;
switching said device from one operational configuration, to another different operational configuration;
enabling or disabling a hardware component of said device;
switching a hardware component of said device, from one operational mode to another different operational mode;
setting up a scheduled future task on said device;
canceling a scheduled future task on said device;
postponing a scheduled future task on said device; and
causing another different computing device or apparatus to perform another different predetermined task.

6. The method of claim 1, wherein determining said likely mode of said activities of said person comprises:
for each predetermined possible mode, determining a prior likelihood for the mode;
for each predetermined possible mode and each collected information item, determining a conditional probability or a conditional probability density of the collected information item in the mode;
determining posterior likelihoods of one or more of said predetermined possible modes using all prior likelihoods and all conditional probabilities or conditional probability densities as determined; and
determining, based on said posterior likelihoods, said likely mode to be one or more modes among said predetermined possible modes.

7. The method of claim 1, wherein determining said likely mode of said activities of said person comprises:
constructing a decision tree applicable to said collected information items, wherein each leaf node of said decision tree represents one or more of said predetermined possible modes;
applying said decision tree to said collected information items to reach a leaf node of said decision tree; and
determining said likely mode to be one or more modes represented by said leaf node.

8. The method of claim 6, wherein for each predetermined possible mode, determining said prior likelihood for the mode comprises:
for each predetermined possible mode, determining a numeric case number;
determining a sum of all case numbers; and
for each predetermined possible mode, determining said prior likelihood for the mode to be the product of:
its case number; and
the multiplicative inverse of said sum.

9. The method of claim 6, wherein for each predetermined possible mode and each collected information item, determining said conditional probability or said conditional probability density of the collected information item in the mode comprises:
determining a group of two or more sets of possible values of the collected information item;
for each set within said group, determining a numeric case number;
determining a sum of all numeric case numbers for all sets within said group;
determining a value of the collected information item and a containing set within said group to which said value belongs; and
determining said conditional probability or said conditional probability density of the collected information item in the mode to be the product of:
the numeric case number for said containing set; and
the multiplicative inverse of said sum.

10. The method of claim 6, wherein determining said posterior likelihoods comprises:
determining said posterior likelihoods using all prior likelihoods and all conditional probabilities or conditional probability densities as determined, according to Bayes' theorem on conditional probability.

11. A method implemented on a network comprising an server and a mobile device, said network operable to communicatively connect said server and said device, the method comprising steps of:
collecting, on said device, one or more information items at or around a given time;
determining, using the collected information items, a likely mode of the activities of a person who at said given time is in close physical proximity to said device, said likely mode being one or more modes among a plurality of predetermined possible modes; and
determining, based on said likely mode or intermediate results of its determination, a likely need of said person, said likely need being one or more needs among a plurality of predetermined needs of said person.

12. The method of claim 11, further comprising:
choosing, on said server, an advertisement among a predetermined set of advertisements, using said likely need or derived data.

13. The method of claim 11, wherein said device is a smart phone, a feature phone, a laptop, a wearable computing device, a tablet, a portable digital sensor, or other portable computing device.

14. The method of claim 11, wherein said device is a group of two or more communicatively connected computing devices, wherein at least one of said computing devices is a smart phone, a feature phone, a laptop, a wearable computing device, a tablet, a portable digital sensor, or other portable computing device.

15. The method of claim 11, wherein said information items comprise at least one item selected from the group consisting of:
said given time;
length of a time interval that begins or ends at said given time;
information about a phone call made or received recently on said device;
whether or not said person is interacting with said device;
linear or angular acceleration measurement taken on said device or related statistics;
angular velocity measurement taken on said device or related statistics;
orientation of said device;
geographic location of said device;
speed of said device;
sound level measured on said device or related statistics;
identification information of detected wireless signal emitters or strengths of their detected signals;
magnitude measurement of an external electric, magnetic, or electromagnetic field taken on said device or related statistics;
ambient air temperature measured on said device or related statistics;
ambient air pressure measured on said device or related statistics;
ambient air humidity level measured on said device or related statistics;
pressure exerted on a touch screen of said device or related statistics;
luminance measured on said device or related statistics;
intensity of an ionizing radiation measured on said device or related statistics;
ambient concentration of a chemical element or compound measured on said device or related statistics; and
a physiological measurement of said person taken on said device or related statistics.

16. The method of claim 11, wherein determining said likely mode and determining said likely need can be implemented:
entirely on said device;
entirely on said server; or
partially on said device and partially on said server.

17. The method of claim 11, wherein determining said likely mode of said activities of said person comprises:
for each predetermined possible mode, determining a prior likelihood for the mode;
for each predetermined possible mode and each collected information item, determining a conditional probability or a conditional probability density of the collected information item in the mode;
determining posterior likelihoods of one or more of said predetermined possible modes using all prior likelihoods and all conditional probabilities or conditional probability densities as determined; and
determining, based on said posterior likelihoods, said likely mode to be one or more modes among said plurality of predetermined possible modes.

18. The method of claim 11, wherein determining said likely mode of said activities of said person comprises:
constructing a decision tree applicable to said collected information items, wherein each leaf node of said decision tree represents one or more of said predetermined possible modes;
applying said decision tree to said collected information items to reach a leaf node of said decision tree; and
determining said likely mode to be one or more modes represented by said leaf node.

19. The method of claim 17, wherein for each predetermined possible mode, determining said prior likelihood for the mode comprises:
for each predetermined possible mode, determining a numeric case number;
determining a sum of all case numbers; and
for each predetermined possible mode, determining said prior likelihood for the mode to be the product of:
its case number; and
the multiplicative inverse of said sum.

20. The method of claim 17, wherein for each predetermined possible mode and each collected information item, determining said conditional probability or conditional probability density of the collected information item in the mode comprises:
determining a group of two or more sets of possible values of the collected information item;
for each set within said group, determining a numeric case number;
determining a sum of all numeric case numbers for all sets within said group;
determining a value of the collected information item and a containing set within said group to which said value belongs; and
determining said conditional probability or said conditional probability density of the collected information item in the mode to be the product of:
the numeric case number for said containing set; and
the multiplicative inverse of said sum.

21. The method of claim 17, wherein determining said posterior likelihoods comprises:
determining said posterior likelihoods using all prior likelihoods and all conditional probabilities or conditional probability densities as determined, according to Bayes' theorem on conditional probability.

22. The method of claim 12, wherein said derived data is one or more words related to or describing said likely need.

23. The method of claim 12, further comprising:
transmitting, from said server to an advertising platform, a component of the chosen advertisement, wherein said platform is communicatively connected to said server.

24. The method of claim 23, wherein said component of said chosen advertisement comprises at least one selected from the group consisting of:
a text,
a graphic,
an animation,
a video segment, and
an audio segment.

25. The method of claim 23, further comprising:
exposing, on said platform, said component of said advertisement to said person.

26. The method of claim 25, further comprising:
determining, on said platform, whether or not a predetermined action is taken by said person after being exposed to said component of said advertisement.

27. The method of claim 23, wherein said platform comprises at least one selected from the group consisting of:
said mobile device,
part of said mobile device, and
another different device.

28. The method of claim 12, further comprising:
transmitting, from said device to said server, an ad request comprising data on at least one selected from the group consisting of:
one or more items among said collected information items;
said likely need;
said derived data; and
static information items about said device or said person.

29. The method of claim 28, wherein choosing, on said server, said advertisement among said set of advertisements, using said likely need or derived data comprises:
choosing a predetermined number of candidate advertisements from said set of advertisements, on said server, based on the received ad request;
for each candidate advertisement, determining a total relevance value; and
determining one or more final advertisements among said plurality of candidate advertisements based on their total relevance values.

30. The method of claim 29, wherein for each candidate advertisement, determining said total relevance value comprises:
for each candidate advertisement, determining a subject relevance score;
for each candidate advertisement, determining an availability score; and
for each candidate advertisement, determining said total relevance value using at least one selected from the group consisting of its subject relevance score and its availability score.

31. The method of claim 30, wherein each candidate advertisement further comprises a predetermined keyword related to a subject of the advertisement, wherein said keyword comprises a first group of words.

32. The method of claim 31, wherein said ad request comprises said derived data, wherein said derived data comprises a second group of words related to said likely need.

33. The method of claim 32, wherein for each candidate advertisement, determining said subject relevance score comprises:
forming a collection of ordered pairs of words, wherein the first word in each pair is one selected from said first group of words and the second word in each pair is one selected from said second group of words;
for each pair in said collection, determining a relevance value for the pair by referencing a predetermined word relevance table, wherein said word relevance table contains one or more numeric values measuring the relevance between two words; and
determining said subject relevance score to be the arithmetic mean of all determined relevance values for all pairs in said collection.

34. The method of claim 30, wherein each candidate advertisement further comprises a predetermined R-table, wherein said R-table contains at least one numeric value measuring relevance between one of said predetermined needs of said person and the advertisement.

35. The method of claim 34, wherein said ad request comprises said likely need.

36. The method of claim 35, wherein for each candidate advertisement, determining said subject relevance score comprises:
for each need in said likely need, determining a need relevance value by referencing said R-table of the candidate advertisement; and
determine said subject relevance score to be the sum of all need relevance values as determined.

37. The method of claim 30, wherein said received ad request comprises at least one selected from the group consisting of the following collected information items:
said given time; and
geographic location of said device.

38. The method of claim 37, wherein each candidate advertisement comprises an available time and an available location, wherein the available time describes the time intervals during which a thing being promoted by the advertisement is available and the available location describes the geographic location where said thing is available.

39. The method of claim 38, wherein said thing can be at least one selected from the group consisting of:
a product,
a service,
a piece of information, and
a view.

40. The method of claim 39, wherein said available time in each candidate advertisement is at least partially represented by a collection of UNIX time intervals.

41. The method of claim 38, wherein said available time in each candidate advertisement is at least partially represented by a collection of calendar day schedules, wherein said calendar day schedules describe time intervals within particular calendar days.

42. The method of claim 38, wherein said available location in each candidate advertisement is expressed in GeoJSON format.

43. The method of claim 38, wherein for each candidate advertisement, determining said availability score comprises:
determining a user response time for the candidate advertisement, wherein said user response time is an estimate of the length of time between when said person decides to respond to the candidate advertisement and when said person takes a predetermined action following that decision;
determining a user action time, wherein said user action time is an estimate of the time instant when said person takes said predetermined action;
determining a time score based on said user action time and said available time of the candidate advertisement; and
determining said availability score based on said user response time and said time score.

44. The method of claim 43, wherein said predetermined action is at least one selected from the group consisting of:
a click;
a transaction;
a download; and
making a phone call.
